(19) United States
(12) Patent Application Publication
(10) Pub. No.: US 2013/0302628 A1
(43) Pub. Date: Nov. 14, 2013

(54) PROTECTIVE COATING

(71) Applicants: Tara J. Shedlosky, Waverly, NY (US); Gordon P. Bierwagen, Fargo, ND (US); Dean C. Webster, Fargo, ND (US); Andrew M. Huovinen, Fargo, ND (US)

(72) Inventors: Tara J. Shedlosky, Waverly, NY (US); Gordon P. Bierwagen, Fargo, ND (US); Dean C. Webster, Fargo, ND (US); Andrew M. Huovinen, Fargo, ND (US)

(73) Assignee: NDSU Research Foundation, Fargo, ND (US)

(21) Appl. No.: 13/866,644

(22) Filed: Apr. 19, 2013

Related U.S. Application Data
(63) Continuation of application No. 11/628,602, filed on Sep. 20, 2007, now abandoned.
(60) Provisional application No. 60/578,373, filed on Jun. 9, 2004.
(60) Provisional application No. 60/602,439, filed on Aug. 18, 2004.
(60) Provisional application No. 60/673,220, filed on Apr. 20, 2005.

(51) Int. Cl. C09D 167/02

(52) U.S. Cl. CPC C09D 167/02
USPC 428/458; 524/604

(57) ABSTRACT

A protective coating including a crosslinked polyester that is removable with a basic composition, as well as coated articles, methods of preparing a protective coating, and methods of using a protective coating.

This application is a continuation application of U.S. patent application Ser. No. 11/628,602, filed on Dec. 5, 2006, which is the §371 National Phase entry of International Application No. PCT/US2005/020318, filed Jun. 9, 2005, which claims the benefit of U.S. Provisional Patent Application Ser. No. 60/578,373, filed Jun. 9, 2004, U.S. Provisional Patent Application Ser. No. 60/602,439, filed Aug. 18, 2004, and U.S. Provisional Patent Application Ser. No. 60/673,220, filed Apr. 20, 2005, which are incorporated herein by reference in their entireties.

### STATEMENT OF GOVERNMENT RIGHTS

This invention was made with government support under Grant No. MT-2210-03-NC-06 awarded by the National Center for Preservation, Training and Technology and Grant No. 0132289 awarded by the National Science Foundation—North Dakota EPSCoR. The government has certain rights in the invention.

### BACKGROUND

Outdoor sculptures are continually exposed to atmospheric elements, including naturally occurring weathering and man-made pollutants, such as acid rain. Pollutants in the atmosphere typically endanger the composition, color, and degree of corrosion of any outdoor object. Bronze, in particular, is especially susceptible to deterioration caused by natural and man-made atmospheric conditions. When unprotected bronze sculpture is exposed to outdoor elements, particularly to acidic conditions, corrosion products, including soluble salts are typically formed. These salts are generally washed away by rainfall, resulting in pitting and discoloration of the bronze. Thus, delaying of corrosion is a constant battle for conservators in maintaining outdoor bronze sculpture. Protective coatings are often used to help protect bronze sculptures from degradation caused by weathering and pollutants.

Materials used in conservation of art must be removable and must be chosen such that they do not damage or change to the artwork. Thus, protective coatings used for outdoor bronze sculptures must protect the work and must also be removable without damaging or changing the sculpture's surface. Protective coatings may be removed by either mechanical methods (e.g., sand blasting and water blasting) and/or by solvents, typically volatile organic compounds (VOCs). Currently, preferred coatings used by conservators to protect outdoor bronze sculpture are those removable only by solvents, such as wax. However, it is known that less permeable coatings provide better protection to the bronze sculpture and allow longer periods between treatments.

More durable protective coatings, such as polyurethane, may be used on bronze sculptures which, when applied to metals and metal alloys such as bronze, provide a high degree of protection. However, more durable protective coatings typically used, such as polyurethanes and crosslinked urethanes, tend to be impervious to conventional solvent removal techniques. Therefore, a disadvantage of using typical polyurethane protective coatings is that they exhibit a higher degree of permanence than is desired by conservators and are typically only removable by mechanical methods. Standard mechanical removal methods, such as sand or water blasting, are typically not desired as they tend to damage the bronze sculptures and their patinas. When solvents are used to remove the protective coatings, typically they are volatile organic compounds (VOCs) that are used in large quantities, resulting in possible health risks to the conservator and environmentally hazardous wastes and pollutants.

While protective coatings useful in the conservation of, e.g., outdoor bronze sculptures are preferably removable, for certain uses, it may be desirable that a protective coating is substantially not removable. For example, it may be desirable to coat metal bathroom fixtures, such as brass fixtures, with a protective coating. While such fixtures are not subject to the weathering of an outdoor sculpture, they are subject to, e.g., humidity, wear and tear, and abrasion with cleaning products. Thus, it may be desirable to protect such fixtures with a coating that is not removable.

### SUMMARY

The present invention provides a coating that protects the metal surface of an object, such as an outdoor sculpture, from exposure to the elements. The coating is particularly well suited for the protection and preservation of bronze objects. In one embodiment, the protective coating is removable from the object without damage to the underlying metal surface. Since durability and removability are typically contradictory properties of a protective coating, the coating of the present invention represents an important advance in the art and science of art conservation.

The removable protective coating of the present invention is durable when exposed to natural weathering and man-made pollutants, yet is removable under controllable, planned chemical decomposition using a high pH remover that is within the range of safe usability by conservators.

The present invention includes an article coated with a protective coating, wherein the coating includes a polyester that includes at least one polyol monomer and at least one polyacid monomer. At least one monomer includes an ionizable group. The polyester is crosslinked with a crosslinking agent to provide a crosslinked polyester coating on the article. The ionizable group preferably does not participate appreciably or at all in the polymerization reaction or the subsequent crosslinking reaction.

The present invention is additionally directed to a protective coating composition, wherein the coating composition includes a polyester that includes at least one polyol monomer and at least one polyacid monomer. At least one monomer includes an ionizable group. The polyester is crosslinked with an isocyanate crosslinking agent to provide a coating that, after application to an article and curing of the protective coating on the article, the protective coating is removable from the article with a removal composition having a pH of about 8 to about 10.

The present invention is also directed to a method for coating an article with a protective coating. A polyester that contains at least one polyol monomer and at least one polyacid monomer, at least one of which contains an ionizable group, is contacted with at least one crosslinking agent to yield a coating composition. A surface of the article is then coated with the coating composition, and the coating composition is allowed to cure on the article. That is, the crosslinking agent crosslinks components of the coating composition to provide a protective coating on the article.

Optional additives, such as solvent(s), hydrophilic component(s), catalyst(s) and the like as discussed in greater detail below, can be included in the composition.

The present invention is further directed to a kit for use in applying a removable protective coating to an article. Such kit conveniently provides to a user the components of the protective coating to be combined and applied to the surface of the article. The kit includes packaging, containing, separately packaged, a polyester comprising at least one polyol monomer and at least one polyacid monomer, wherein at least one monomer comprises at least one ionizable group; and at least one crosslinking agent.

### BRIEF DESCRIPTION OF THE DRAWINGS

FIG. 1—Diagram of a setup using a Allihn condenser and a Friedrichs condenser used in the synthesis of certain polyesters.

FIG. 2—Graph of the Response Surface of a coating including TMXDI and PEG 200.

FIG. 3—Graph of the Response Surface of a coating including TMXDI and PPG.

FIG. 4—Graph of the Response Surface of a coating including TMXDI and PLURONIC 17R2.

FIG. 5—Graph of the Response Surface of a coating including TMXDI and PLURONIC L61.

FIG. 6—Graph of the Response Surface of a coating including TMXDI and PLURONIC L31.

FIG. 7—Graph of the Response Surface of a coating including DESMODUR and PEG 200.

FIG. 8—Graph of the Response Surface of a coating including DESMODUR and PPG.

FIG. 9—Graph of the Response Surface of a coating including DESMODUR and PLURONIC 17R2.

FIG. 10—Graph of the Response Surface of a coating including DESMODUR and PLURONIC L61.

FIG. 11—Graph of the Response Surface of a coating including DESMODUR and PLURONIC L31.

FIG. 12—Graph of the Response Surface of a coating including CYTHANE 3174 and PEG 200.

FIG. 13—Graph of the Response Surface of a coating including CYTHANE 3174 and PPG.

FIG. 14—Graph of the Response Surface of a coating including CYTHANE 3174 and PLURONIC 17R2.

FIG. 15—Graph of the Response Surface of a coating including CYTHANE 3174 and PLURONIC L61.

FIG. 16—Graph of the Response Surface of a coating including CYTHANE 3174 and PLURONIC L31.

FIG. 17—Graph of gloss at a 20 degree angle over time of exposure of polished bronze coated samples.

FIG. 18—Graph of gloss at a 20 degree angle over time of exposure of patinated bronze coated samples.

FIG. 19—Graph of the average contact angle vs. time of exposure of the coatings on polished bronze.

FIG. 20—Graph of the average contact angle vs. time of exposure of the coatings on patinated bronze.

FIG. 21—Graph of ΔE vs. time of exposure of the coatings on polished bronze.

FIG. 22—Graph of ΔE vs. time of exposure of the coatings on patinated bronze.

FIG. 23—Graph of coating thickness vs. time of exposure on polished bronze.

FIG. 24—Graph of coating thickness vs. time of exposure on patinated bronze.

FIG. 25—Graph of Noise Resistance vs. time of exposure of coated polished bronze.

FIG. 26—Graph of Noise Resistance vs. time of exposure of coated polished bronze, including trend lines of the Rₙ values.

FIG. 27—Graph of Noise Resistance vs. time of exposure of coated patinated bronze, including trend lines of the Rₙ values.

FIG. 28—Graph of the initial Bode Plot of the polished samples.

FIG. 29—Graph of the week 2 Bode Plot of the polished samples.

FIG. 30—Graph of the week 4 Bode Plot of the polished samples.

FIG. 31—Graph of the initial Bode Plot of the patinated samples.

FIG. 32—Graph of the week 2 Bode Plot of the patinated samples.

FIG. 33—Graph of the week 4 Bode Plot of the patinated samples.

FIG. 34—Graph of ultraviolet absorption changes during exposure for Coating 10.

### DETAILED DESCRIPTION OF ILLUSTRATIVE EMBODIMENTS

The present invention responds to a need in the art for a protective coating for metal objects, such as sculptural artworks, decorative trim, and the like, that provides both durability and removability under the standards set for conservator restorations. Bronze is particularly susceptible to deterioration resulting from the corrosive effects of atmospheric conditions such as moisture, heat, oxygen, ultraviolet (UV) light, and chemical pollutants. Advantageously, the removable protective coating is particularly well-suited for objects with bronze surfaces that are displayed outdoors.

Bronze is an alloy having copper and tin components (Penny, The Materials of Sculpture, Yale University Press, New Haven, Conn., pages 219-255 (1993)). Copper is maleable and machinable, but has poor mechanical properties, thus tin is added to provide a harder material. Lead is optionally added to lower the melting temperature and increase machinability (Scott, Copper and Bronze in Art Corrosion, Colorants, Conservation, first edition, Getty Publications, Los Angeles, Calif. page 515 (2002); Davis, ed., “Physical Metallurgy: Heat Treatment, Structure and Properties,” in ASM Specialty Handbook, ASM International, Materials Park, Ohio (2001)). While the smelting of zinc with copper provides the alloy known as brass, such alloys are often referred to as “bronzes” with respect to art objects. Thus, unless otherwise indicated, the term “bronze” as used herein to describe an object also includes brass objects.

Bronze alloys may include additional metals, depending upon, e.g., the need for finely-detailed castability, cost, intended use (e.g., outdoor sculpture), etc. Such alloys may additionally include nickel, aluminum, silicon, etc. Currently, the most common bronze alloy used commercially is C83600, also known as 85-5-5-5 (85% copper, 5% tin, 5% lead, and 5% zinc).

In addition, bronze used for sculpture may be polished or patinated (naturally or artificially). While a polished surface is smooth, a patinated surface may be somewhat uneven. Thus, each surface provides particular problems in providing a removable protective coating.

A patina is a layer of corrosion on the surface of an object. A distinction made between a desirable patinated object and an undesirable corroded object is that a patina may be thought to be a smooth, continuous layer that preserves detail and shape, while corrosion is mineral deposits that do not form a continuous and smooth layer (Scott, Copper and Bronze in Art Corrosion, Colorants, Conservation, first edition, Getty Publications, Los Angeles, Calif. (2002)).

An object may be patinated by natural means simply by exposing the surface to the environment, or, alternatively, an object may be patinated by artificial means (Weil, “A review of the history and practice of patination,” in Corrosion and Metal Artifacts—A Dialog between Conservators and Archaeologists, and Corrosion Scientists, National Bureau of Standards, Gaithersburg, Md., 77-92 (1977)), e.g., by applying chemicals with or without added heat. When a patina is formed, it does so at the expense of loss of material of the object itself. Furthermore, artificial patinas are never completely stable, tending to change and develop new mineral forms over time. It is typically desirable to coat artificially patinated articles directly after patination to retard further, undesirable, corrosion.

A clear protective coating is desirable to retard and/or prevent corrosion on polished bronze surfaces and also to retard and/or prevent further undesirable corrosion on patinated bronze surfaces. As indicated above, it is often desirable, however, to be able to remove such protective coatings e.g., to provide maintenance to the bronze surfaces and also to comply with the conservator's ethics of conservation, which includes a duty to preserve artwork and ensure that anything applied to artwork is reversible such that whatever transpires through, e.g., a restoration process, the final appearance of the work can be returned to its previous state (AIC: Code of Ethics of the American Institute for Conservation of Historic and Artistic Works, Directory of The American Institute for Conservation of Historic and Artistic Works, Washington, D.C., (2005)).

The present invention provides a coating composition that protects the metal surface of an object, such as an outdoor sculpture, from exposure to the elements. The protective coating composition includes a crosslinked polyester that, when applied to metals, is durable in the presence of, e.g., weather conditions and pollutants, but is able to break down and be removed from the metal when a high pH material is applied.

To evaluate the durability of a coating, it is exposed to weathering, e.g., exposure to accelerated weathering in a fog/humidity chamber for a period of four weeks, for example, and subjected to various physical and electrochemical tests, as described in Example 4, below, to determine how intact the coatings remain after weathering. The coatings are compared to a coating of INCRALAC (Stan Chem, Inc., East Berlin, Conn.), a coating commonly used in conservation, and each coating is subjectively evaluated as “more durable” or “less durable” than the INCRALAC (Stan Chem, Inc., East Berlin, Conn.) coating.

### Polyester

The polyester used in the coating compositions of the present invention is formed from at least two monomers: at least one alcohol monomer and at least one acid monomer. The alcohol monomer is preferably a polyol. A polyol can have two hydroxyl groups (diols) or more than two hydroxyl groups (e.g., triols, tetraols and so on). Diols useful for polyester synthesis in accordance with the invention include, for example, dimethylolpropionic acid (DMPA); hexanediol (HD); 1,5-pentanediol; ethylene glycol (EG); 1,2-propylene glycol (PG); 1,3-propylene glycol; 2-methyl-1,3-propanediol (MPD); 2,2-dimethyl-1,3-propanediol (neopentylglycol, NPG); 2-butyl,2-ethyl-1,3-propanediol (BEPD); 1,4-cyclohexanedimethanol (CHDM); 2,2,4-trimethyl-1,3-pentanediol (TMPD); hydroxypivalylhydroxypivalate (HPHP), and the like. Polyols having more than two hydroxyl groups per molecule can be used to provide branching to the polyester resin. These include, for example, trimethylolpropane (TMP); trimethylolethane (TME); glycerol; pentaerithritol (PE); di-trimethyolopropane (di-TMP), and the like. A preferred polyol is DMPA.

The acid monomer is preferably a polyacid (a compound with at least two carboxylic acid groups). Typically, the acid monomer is a diacid. Diacids include, for example, adipic acid (AD or AdA); phthalic anhydride (PA); phthalic acid; isophthalic acid (IPA); terephthalic acid (TPA); glutaric acid; succinic anhydride; succinic acid; maleic anhydride; maleic acid; itaconic acid; itaconic anhydride; 1,4-cyclohexanedicarboxylic acid (1,4-CHDA); 1,3-cyclohexanedicarboxylic acid (1,3-CHDA); hexahydrophthalic anhydride (HHPA); hexahydrophthalic acid; methylhexahydrophthalic anhydride; and tetrahydrophthalic anhydride. Preferred diacids are 1,4-CHDA and IPA, AD and/or their mixtures. Most preferred are those polyesters containing 1,4-CHDA alone or in combination with IPA.

In the polymerization reaction, a hydroxyl group of one monomer reacts with a carboxylic acid group on the other monomer to form an ester linkage, resulting in a polyester. Optionally, the polyester can include more than one constituent polyol monomer and/or more than one constituent polyacid monomer.

The acid and alcohol monomer constituents of the polyester are selected based on the desired contribution to the performance properties of the coating. The selected monomers provide characteristics to the coating compositions including, for example, additional flexibility in the cured coating composition, ability to further control T_{g} of the polymer, a means for increasing or decreasing the amount of branching (e.g., by controlling the amount of a triol such as TMP), and additional alcohol and acid groups to promote crosslinking. For example, the inclusion of an aromatic monomer can make the polyester harder and less flexible, whereas the inclusion of an aliphatic monomer can make the polyester softer and more flexible.

The ratio of hydroxyl groups to carboxylic acid groups (specifically, those groups that participate in the polymerization reaction) is selected to achieve a desired polymer molecular weight. If the ratio of hydroxyl groups to carboxylic acid groups is 1:1, a high molecular weight and high viscosity polymer is obtained. Typically, it is desirable to limit the molecular weight of the polymer by using an excess of monomers containing one of the functional groups that participate in polymerization. In the present invention, it is preferred to use an excess of hydroxyl groups over participating carboxylic acid groups. The excess, unreacted hydroxyl groups are then available for crosslinking with the crosslinker, such as isocyanate. Preferably, the ratio of hydroxyl groups to carboxylic acid groups (OH:COOH) is at least about 1.05. More preferably, the OH:COOH ratio is between about 1.05 and 1.5, and a preferred polymer is one that has a hydroxyl equivalent molecular weight of about 200 grams per equivalent to about 5000 grams per equivalent. Note that carboxylic acid groups that do not participate in the polymerization reaction, such as the carboxylic acid group of DMPA, are not included in this ratio.

At least one constituent monomer of the polyester is dually functional in that, in addition to containing functional groups that participate in the polymerization reaction, it contains an ionizable group. It was discovered that the inclusion, in at least one constituent monomer, of an ionizable group that does not participate appreciably in the polymerization reaction facilitates removal of the coating composition at high pH. Without being limited to any particular theory of operation, it is believed that monomers including ionizable group of the present invention may preferably attract water at high pH (e.g., pH of about 8 to about 10), thereby facilitating removal of the composition. Examples of ionizable groups include a carboxylic acid and a sulfonate. The amount of ionizable monomer in the polyesters of the invention is that which yields, after application to the object, a crosslinked polyester coating that achieves a balance between stability at low or neutral pH and removability at high pH. The ionizable monomer is typically present in the polyesters in the amount of at least about 2 weight percent, more typically at least about 6 weight percent, based on total weight of the polyester. Further, the ionizable monomer is typically present in the polyesters in the amount of no greater than about 10 weight percent, more typically no greater than about 8 weight percent, based on total weight of the polyester.

An example of a dually functional constituent monomer that contains at least two hydroxyl groups (for the polymerization reaction) and a carboxylic acid group (the ionizable group) has the following structure:

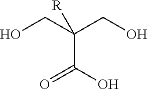

where R is an alkyl group (e.g., methyl, ethyl, butyl, etc.). One such a monomer is dimethylolpropionic acid (DMPA), where R is a methyl group. The carboxylic acid group in the polyol DMPA is sterically hindered and tertiary, and thus is much less reactive than the other carboxylic acid groups involved in polymerization. The polymerization reaction thus proceeds primarily through the hydroxyl groups of DMPA, but the carboxylic acid group of DMPA does not react substantially. The ionizable group may be protected sterically (as in DMPA), or, alternatively, it may be protected using, e.g., a protecting group that is removed prior to crosslinking the polyester.

An example of a dually functional constituent monomer that contains at least two carboxylic acid groups (for the polymerization reaction) and a sulfonate group (the ionizable group) is 5-sodiosulfoisophthalaic acid, which has the following structure:

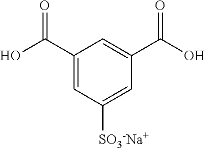

The polymers of the invention are synthesized by melt polyesterification processes which are known to those skilled in the art. The polyesterification reaction is carried out at a temperature of at least about 160° C., preferably at least about 180° C., and a temperature of no greater than about 250° C., preferably no greater than about 220° C. The water of the esterification is distilled from the reaction flask and can optionally be facilitated through the use of a small amount of an azeotroping solvent, such as toluene, xylene, methyl amyl ketone, and the like.

Optionally, a catalyst is used to increase the rate of esterification (hence polymerization). Any catalyst that increases the esterification rate of the reaction may by used, such as dibutyltin oxide (DBTO), tetrabutyloxytitanate, dibutyltin dilaurate, n-butyltin trioctoate, sulphuric acid, sulphonic acid, methane sulfonic acid, para-toluene sulfonic acid, and the like.

When the ionizable group is a carboxylic acid, the polymerization reaction is preferably carried out until an acid number of no less than about 32 milligrams (mg) potassium hydroxide (KOH) per gram (g) of resin (mg KOH/g) is obtained. The acid number expresses the acidity of a solution and is determined by a standard titration test that is well known in the art. Preferably the acid number of the synthesized polymer is no less than about 36 mg KOH/g, more preferably it is no less than about 39 mg KOH/g. Additionally, the acid number of the synthesized polyesters is preferably no greater than about 44 mg KOH/g, and more preferably no greater than about 40 mg KOH/g. A preferred range of KOH/gram is 39-40 mg KOH/gram polyester.

### Crosslinking Agents and Removable Coating Compositions Provided Thereby

To form a durable coating, the polyester is crosslinked with a crosslinking agent during the application of the coating to the object. Crosslinking of the polyester of the invention is accomplished by combining the polyester and one or more selected crosslinking agents in an organic solvent, such as methyethylketone (MEK). In one embodiment, the selected polyester, crosslinking agent, and any optional additives, as described below, are of the type and quantity to provide a coating composition that has a T_{g} (glass transition temperature) of at least about 20, preferably at least about 25. Typically, the polyesters of the reaction are not amine-neutralized prior to crosslinking.

Crosslinking agents of the present invention are those capable of reacting with hydroxyl groups on the polyester. These include isocyanate functional resins, amino resins, such as melamine-formaldehyde resins or urea formaldehyde resins, epoxy resins, etc. Preferred crosslinking agents are isocyanate functional resins, more preferably, difunctional isocyanate and trifunctional isocyanate resins, optionally substituted with structures such as aromatic rings. Isocyanate functional resins will react with a polyester resin to form a cured coating at ambient temperatures, and are known to provide durable coatings. Suitable isocyanate compounds include aromatic isocyanates, such as toluene diisocyanate, methylphenyl diisocyanate (MDI), and polymeric MDI and aliphatic isocyanates, such as hexamethylene diisocyanate, hydrogenated MDI, isophorone diiscyanate, and tetramethyl-m-xylidene diisocyanate (TMXDI, Cytec Industries, West Paterson, N.J.). Aliphatic isocyanates are typically preferred, since coatings based on aromatic diisocyanates generally have poor outdoor weatherability.

While it is expected that any isocyanate would be an effective crosslinking agent, monomeric isocyanates may cause serious health problems, such as skin rashes and asthma. Therefore, to provide protection to the user, adducts and oligomers of the monomeric isocyanates and diisocyanates are preferably used. The isocyanate adducts and oligomers are preferred over the diisocyanates since the polymers have three or more isocyanate groups per molecule, and the level of the more hazardous monomeric diisocyanate is low. The isocyanate adducts and oligomers have three or more isocyanate groups per molecule and the level of the more hazardous diisocyanate is lower. Such adducts and oligomers include, for example, biuret and isocyanurate resins from HDI, and adducts of diisocyanates with a polyol, for example, hexamethylene diisocyanate isocyanurate (DESMODUR N3300A, Bayer MaterialScience, Pittsburgh, Pa.) and CYTHANE 3174 (Cytec Industries, West Paterson, N.J.) polyisocyanate resin, which is the reaction product of TMXDI with trimethylolpropane, and so on.

The amount of crosslinker used in the coatings of the invention is defined by the stoichiometric ratio of, e.g., isocyanate groups to hydroxyl groups (NCO:OH). At low NCO:OH ratios, hydroxyl groups on the polyester will remain unreacted and the overall crosslink density (e.g., the number of moles of crosslinks per volume of material, typically expressed as moles per centimeter³) of the coating will be low, providing a coating that is tacky and typically will not cure completely. At high NCO:OH ratios, the excess crosslinker, e.g., isocyanate, can react with atmospheric moisture and convert to amine with the elimination of carbon dioxide. The amine is expected to react with, e.g., additional isocyanate groups to form urea crosslinks. At higher NCO:OH ratios, the coatings tend to be brittle, due to the extra crosslinks.

NCO:OH ratios of coating of the invention may vary widely, and acceptable ranges depend on, e.g., the structure of the crosslinker and the polyol, their equivalent weights, and the desired durability of the coating. For example, in the examples described below, removable coatings including TMXDI as a crosslinker are characterized by an NCO:OH ratio of about 3:1 (3 to 1) to about 3.5:1 (3.5 to 1), while removable coatings including CYTHANE 3174 as a crosslinker are characterized by an NCO:OH ratio of about 2.2:1 (2.2 to 1) to about 2.6:1 (2.6 to 1). Removable coatings including DESMODUR as a crosslinker are characterized by an NCO:OH ratio of about 0.3:1 (0.3 to 1) to about 1.6:1 (1.6 to 1), and an NCO:OH ratio of about 1.6:1 (1.6 to 1) when a hydrophilic monomer (e.g., PPG or a PLURONIC surfactant, discussed below) was added.

The isocyanates of the invention are preferably crosslinked with the polyester in a ratio of NCO:OH having a value of at least about 0.3:1 (0.3 to 1), preferably at least about 0.5:1 (0.5 to 1), more preferably at least about 0.9:1 (0.9 to 1), depending upon the isocyanate crosslinking agent used. The isocyanates are preferably crosslinked with the polyester in a ratio of NCO:OH having a value of at most about 3.5:1 (3.5 to 1), preferably no greater than about 3:1 (3 to 1), more preferably no greater than about 2.6:1 (2.6 to 1) even more preferably no greater than about 2.2:1 (2.2 to 1), still more preferably no greater than about 1.6:1 (1.6 to 1), yet more preferably no greater than about 1.3:1 (1.3 to 1), and most preferably no greater than about 1.1:1 (1.1 to 1).

Optionally, a catalyst can be used to catalyze the hydroxyl-isocyanate crosslinking reaction. Catalysts typically used for polyurethane systems include salts of metallic compounds, e.g., mercury, zinc, bismuth, tin, etc. Tin salts are preferred crosslinking catalysts, and catalysts such as dibutyltin dilaurate and dibutyltin diacetate are more preferred.

To provide the protective coating on an article, e.g., a bronze sculpture, the selected polyol and polyacid monomers are polymerized to form a polyester of the invention. To the polyester, a solvent, for example methyl ethyl ketone (MEK) is added, and optional components, such as a catalyst, and hydrophilic components and optional additives, as discussed below, are added. To this mixture, the crosslinking agent is combined, and the resulting composition is applied to the surface of the article. Over a period of time, preferably two to three weeks, the composition is allowed to cure on the article (e.g., the polyester is crosslinked by the crosslinking agent) to provide the article coated with a protective coating according to the invention.

### Hydrophilic Components

Optionally, the coating composition further includes a hydrophilic component, which is typically added to the composition after synthesis of the polymer and prior to adding the crosslinking agent. The purpose of the hydrophilic component is to swell the crosslinked coating beyond the swelling provided by the high pH removal composition (discussed more fully below), thus assisting in the removal of the protective coating. The hydrophilic component contains a functional group, such as a hydroxyl, that reacts with the crosslinker. Thus, although the hydrophilic component does not form part of the polyester (the polyester is already formed when the hydrophilic component is added) it does, like the polyester, react with the crosslinker. When it contains hydroxyl groups, the hydrophilic component can be used in place of a portion of the other polyol monomer(s) in order to maintain the desired NCO:OH ratio.

Examples of preferred hydrophilic compounds are of the class of polyether polyols, such as poly(ethylene glycol) ranging in molecular weights from about 200 to about 1000 (e.g., PEG 200 to PEG 1000), polypropylene glycol (PPG), and PLURONIC block copolymers such as PLURONIC 1782, PLURONIC L61, and PLURONIC L31 (all PLURONIC surfactants obtained from BASF Corporation, Florham Park, N.J.). Preferred hydrophilic compounds include PPG, PLURONIC L61, and PLURONIC 17R2.

The hydrophilic additives, when included, are typically present in the coating composition in the amount of no more than 13 weight percent (wt %), preferably no more than 10 wt %, and more preferably no more than 5 wt %, based on the total weight of the polyester component.

### Optional Additives

When the protective coatings of the present invention are used to protect objects intended for outdoor display, additional components may be added that further provide protection from, e.g., ultraviolet (UV) radiation and photo-oxidation degradation. Such additional components may protect the polymer coating, thereby protecting the underlying substrate, by absorbing/filtering out UV radiation (e.g., by adding a radical scavenger or peroxide decomposing agent), by providing fungicidal properties, and by providing a hindered amine light stabilizer (HALS). A leveling agent may also be included in the coatings. Examples of these additional components include fungicides, matting agents, wetting agents, hydroxyphenyl benzotriazoles, and hindered amine light stabilizers (HALS), such as TINUVIN 1130 Light Stabilizer (Ciba Specialty Chemicals, Inc., Tarrytown, N.Y.) and TINUVIN 292 Light Stabilizer (Ciba Specialty Chemicals, Inc., Tarrytown, N.Y.). A UV absorber and a HALS may be used separately or in combination. When used in combination, a typical formulation may include about 2 weight percent of the hydroxyphenyl benzotriazole UV absorber and about 1 weight percent HALS, based on total weight of the coating components.

Additionally, a solvent may be used to solubilize the crosslinked polyester coating composition and reduce the viscosity of the composition sufficiently for application. Solvents for polyester-urethane coatings can be aromatic solvents, such as toluene, xylene, aromatic 100, etc.; ester solvents, such as butyl acetate, amyl acetate, methyl acetate, etc.; ketone solvents, such as acetone, methyl ethyl ketone (MEK), methyl amyl ketone, etc.; or a combination thereof. Combinations of solvents are preferred.

A further additional component is a pot-life extender. These additives are included to extend the working time of the coating after the components are polymerized and crosslinked. Pot-life extenders are known in the art and include compounds such as 2,4-pentanedione, acetic acid, etc.

### Protective Coating Kits

The present invention further provides a kit that includes, in separately packaged containers, a polyester and a crosslinking agent, as described herein. For example, the polyester, as described above, can be provided in one container, such as a jar, squeeze tube, bottle, etc, and the crosslinking agent(s) are provided in another, separate container, such as a jar, squeeze tube, bottle, etc. The containers optionally include indicia to indicate volume of the contents, facilitating mixing only a portion of the components. In this instance, the containers are optionally reclosable. The user then opens each separate container, combines contents of each container to form a mixture, applies the mixture to the surface to be coated, and allows the mixture to cure (e.g., crosslink) on the surface to form the removable, protective coating.

Since a user, such as an art conservator, often needs to provide a protective coating to articles in various locations, e.g., application to a bronze sculpture intended for outdoor display, a kit that supplies the separately packaged coating components of the coating composition is particularly advantageous.

The kit may include a separately packaged solvent, and may also include optional components, such as one or more catalysts, one or more hydrophilic components, and one or more of the optional additives described above. Each of the optional components may be packaged in separate containers, or one or more of the optional components may be packaged in a single container. Furthermore, one or more of the optional components may be packaged in the same container as the crosslinking agent or the polyester. Mixing directions for, e.g., making various batch sizes, directing when to add optional components, etc., may also be included in the kit. The kit may further include such items as applicator brushes, applicator sponges, mixing vessels, etc.

### Use of the Protective Coating

The present invention is also directed to methods of using the removable protective coating to protect surfaces of objects such as bronze sculpture intended for outdoor display. The coating is applied and allowed to cure (e.g., for a time period of, preferably, about 2 weeks to about 6 weeks), yielding an essentially clear protective coat that is durable to the outdoor elements. The coating can later be removed using the removal composition, as discussed further below, with light abrasion with a soft tool such as a plastic scraper, and a thorough water rinse.

### Removal Composition

Removable coatings of the present invention may be removed using a basic removal composition, preferably a high pH composition. The removal composition is applied to the coating and allowed to penetrate the coating for a predetermined period of time, after which the coating is lightly rubbed or abraded, e.g, with a plastic scraper or other soft tool that provides essentially no alteration of the surface of the substrate. The coated surface is then rinsed well with water to substantially completely remove the removal composition and the coating.

The high pH of the removal compositions for removing protective coatings is understood to mean a removal composition that has a pH of about 8 or greater. Preferably, the removal compositions have a pH of about 9 or greater. A removal composition of the invention preferably has a pH of no greater than about 10, for the reason that a removal composition more basic than a pH of about 10 may adversely affect the substrate.

While any type of composition having a pH of about 8 or greater may be used to remove the coatings of the invention, provided the composition does not adversely affect the substrate, such as a liquid in which a coated article may be immersed, the removal compositions are preferably provided in the form of a gel. A gel is conveniently applied to e.g., a vertical surface, and may remain on that surface for the prescribed period of time. Removal compositions used to remove coatings of the invention preferably are applied to the coating to be removed and allowed to penetrate the coating for at least about 20 minutes prior to rinsing. Removal compositions that require less time to remove the protective coatings may, for example, be too aggressive to be an appropriate coating removal composition and, thus, may damage the underlying sculpture. On the other hand, it is at least inconvenient to use a coating removal composition that requires too much time to penetrate the coating prior to rinsing. Thus, preferred removal compositions are preferably left on the protective coating no longer than about one hour, preferably no longer than about 30 minutes.

Removal compositions useful to remove coatings of the invention include, for example, a polyvinyl alcohol gel and a sodium hydroxide solution. The polyvinyl alcohol gel is made by dissolving polyvinyl alcohol in deionized water, adding to this a sodium tetraborate solution, and adjusting the pH with a solution of ammonia and deionized water. A dilute sodium hydroxide solution provides a removal composition in which a coated article may be immersed.

A preferred removal composition is the varnish remover SAFEST STRIPPER (3M Company, St. Paul, Minn.) with a pH adjusted by adding ammonium hydroxide (NH₄OH) to the varnish remover until the pH of the system is about 9.

Removable coatings of the invention may be used to provide a variety of coated articles, including metal sculptures for indoor display, metal sculptures for outdoor display, and any other metal fixtures for indoor or outdoor use, such as metal patio furniture. The removable coatings are particularly useful for providing coated polished bronze sculpture and coated patinated bronze sculpture, articles, which are not easily transported indoors, to protect them from natural and man-made outdoor elements.

### Nonremovable Coatings

As described in Example 4, below, it was surprisingly found that some of the coatings tested become less removable, rather than more removable, under weathering conditions. This was quite unexpected. These coatings are, for example Coatings 1, 5, 7, 8, 9, and 10 of Example 4, wherein a polyester including DMPA and 1,4-CHDA is crosslinked with the isocyanate crosslinker DESMODUR N-3300 (Bayer MaterialScience, Pittsburgh, Pa.) in a ratio of 1.1:1, NCO:OH, useful for applications in which removability of the coating is not desired.

Accordingly, in another aspect the present invention includes protective coating compositions wherein the coating is not removable, thus providing essentially permanent protection of the underlying substrate. Such coatings, not removable by either water or a basic removal composition are particularly beneficial for the protection of metal household articles, such as high end bathroom and kitchen fixtures, which are typically subject to high humidity and abrasive cleansers. These coatings provide a clear protection to, e.g., bathroom fixtures that, surprisingly, become more resistant to weathering (e.g., the heat and humidity typically present in bathrooms) with time, rather than wearing away, as was expected to happen.

Further, it is typically difficult to apply a clear coat to a metal surface that adheres well to the metal surface. In most cases, a primer coat of some type is required. Using a primer not only requires an additional step, it also requires an additional layer of coating on the article, providing unwanted bulk that may well obscure delicate ornamental detail present in the underlying metal substrate. Furthermore, such primer coats are often opaque, and would mask the color of the metal. The present non removable coatings are easily applied to metal surfaces and do not require a primer coat.

Nonremovable protective coatings of the invention include a polyester that includes at least one acid and one alcohol, such as the monomers used to synthesize the polyesters described in Example 1, below (polyesters 1-4, which do not include DMPA). These monomers are polymerized and crosslinked with a crosslinking agent at a crosslink density of NCO:OH of greater than 1.1:1.

### EXAMPLES

Exemplary embodiments of the present invention are described below. Those skilled in the art will recognize that many embodiments are possible within the scope of the invention. Other variations, modifications, and combinations of the various parts and assemblies can certainly be made and still fall within the scope of the invention.

Unless otherwise indicated, the polished and patinated bronze samples used in the Examples below were prepared as follows.

Bronze Casting

Bronze samples were cast at the Johnson Atelier in Mercerville, N.J. The bronze was cast using Leaded Red Brass ingots (ASTM B30) purchased from Colonial Metals Company (Colombia, Pa.). The composition of the bronze was 85% copper, 5% tin, 5% zinc, and 5% lead. The bronze was sand cast, with an approximately ¼ inch thickness. The bronze was subsequently cut into one hundred 4 inch by 6 inch samples.

A portion of these bronze plates were polished to a satin finish by sanding with a 80 grit disk, a 120 grit disk, and a 4.5 inch 3M blue surface conditioning pad (3M Company, St. Paul. MN). This was followed by polishing with an orbital sander using 220 grit abrasives, followed by sanding with a red 3M conditioning pad (3M Company, St. Paul, Minn.).

Twenty five samples were artificially patinated with a French brown patina using the following procedure. The samples were first sanded using a 120 grit disk, then glass bead blasted. Liver of Sulfur (ammonium sulfide) was then applied cold. The surface was rubbed with a red 3M conditioning pad (3M Company, St. Paul, Minn.) and rinsed with distilled water. The samples were then heated with a propane torch and a ferric nitrate/distilled water solution was applied.

All pH values reported in the following Examples were measured with Baker pH IX pH testing strips, obtained from Mallinckrodt Baker, Inc. (Phillipsburg, N.J.), and were evaluated visually.

### Example 1

### Synthesis and Analysis of Polyesters 1, 2, 3, and 4

The type of coatings investigated were isocyanate crosslinked polyesters. The building blocks of the polyester included a component that becomes water-soluble when exposed to a high pH environment. It was thought by varying the hydrolytic stability of the components, the resultant urethane coatings would have different resistances to a high pH gel. This would allow a conservator to apply a nontoxic gel to the coated sculpture and remove the durable coating without significant damage to the bronze itself. Combinatorial/high throughput methods and equipment were used to make the various coating formulations.

The initial approach to develop a removable polyurethane was to:

1. Synthesize various polyesters that each have a different hydrolytic stability;
2. Crosslink with an isocyanate, varying crosslink densities;
3. Add poly(ethylene glycol) (PEG), a hydrophilic monomer, at varying molecular weights to increase solubility of decomposition products; and
4. Test removability using high pH gel/liquid and water.

Synthesis of the polyesters was accomplished by esterification of a polyacid and a polyol in a step-growth condensation reaction, as shown in the following reaction scheme:

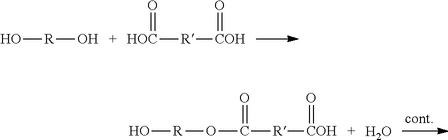

The reaction of a polyol and polyacid to form a polyester and water.

Typically, several different polyols and polyacids are used to achieve desired properties of the polyester. In designing a synthesis reaction, the functionality and ratio of the reacting monomers is important. Often, an excess of polyol is used, providing hydroxyl functionality to the resultant polyester. It is, thus, possible to control the functionality of the polyester by controlling the stoichiometry of the polyols and polyacids used. Polyesters may be synthesized to be linear or branched. Branching will occur if the R groups of the monomers are multifunctional. If there is a high enough concentration of multifunctional groups, and if the reaction is allowed to continue to completion, it is likely that gelation of the product will occur.

Polyesters may be formulated to have excess hydroxyl groups to be used for crosslinking. The polyester urethane is made by crosslinking a multifunctional, hydroxyl-terminated polyester with an isocyanurate as seen in the following reaction scheme:

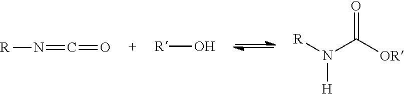

### The Crosslinking Reaction of an Isocyanate and an Alcohol Group

In this example, coatings were developed by crosslinking a multifunctional, hydroxyl-terminated polyester with an isocyanate according to the above scheme.

Monomeric isocyanates are known in the art to be sensitizers, wherein exposure to them may lead to serious health concerns, such as skin rashes and asthma. Thus, instead of using these potentially harmful compounds, adducts of monomeric isocyanates are often used. The increased molecular weight of the adducts reduces the vapor pressure and, thus, skin permeability of the isocyanate. Improved crosslinking efficiency is also provided by the use of adducts of monomeric isocyanates.

A goal of this research was to identify crosslinked polyesters crosslinked in ratios that results in polyester polyurethanes that provide protection to metal, and that break down when a high pH material is applied. A base-catalyzed hydrolysis reaction, as shown in the reaction scheme below, was the basis for removability of the coatings:

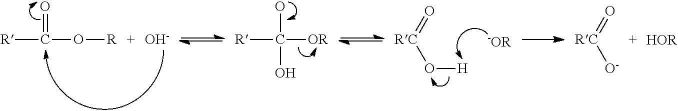

### Base-Catalyzed Hydrolysis Reaction

It was believed that by varying the hydrolytic stability (e.g., the resistance to hydrolysis) of the coating components, the resultant urethane coatings would have different resistances to a high pH gel. Thus, different polyesters with varying hydrolytic stabilities were synthesized and crosslinked, providing coatings that were examined for durability and removability.

In addition to relying solely on the base-catalyzed ester hydrolysis reaction, a hydrophilic component was added to certain systems before crosslinking. It was believed that once the polyester was hydrolyzed and broken down into smaller molecular weight chains, the hydrophilic component would swell, increasing the removability of the coating system. Thus, poly(ethylene glycol) (PEG), a hydrophilic monomer, was introduced, at various molecular weights, into coating compositions including the synthesized and crosslinked polyesters to increase solubility of the decomposition products.

### Monomer Selection

Four polyesters were initially synthesized, varying the diol that was used. Isophthalic acid (IPA) (Eastman Chemical Company, Kingsport, Tenn.) and adipic acid (AdA) (DuPont, Wilmington, Del.) were included in various concentrations in each of the four polyesters, according to the synthesis described below.

The four diols used were cyclohexanedimethanol (CHDM), neopentyl glycol (NPG), 1,6-hexanediol (HD), all supplied from Aldrich Chemical Company (Sigma-Aldrich, St. Louis, Mo.), and ethylene glycol, supplied from Dow Chemical Company (Somerset, N.J.). The triol used was trimethylol propane (TMP), supplied from Aldrich Chemical Company (Sigma-Aldrich, St. Louis, Mo.). All materials were used as received from the suppliers without further purification. The polyols used were chosen for their different hydrolytic stabilities, predicted by Turpin's variant of Newman's Rule of 6 (Wicks et al., Organic Coatings, Second Ed., Wiley & Sons, New York, N.Y. (1999)). A higher hydrolytic stability represents a molecule that is more resistant to hydrolysis.

### Synthesis of Polyester 1

Under a nitrogen blanket, a mixture of monomers and the transesterification catalyst dibutyltin oxide (DBTO) 98%, supplied by Aldrich Chemical Company (Sigma-Aldrich, St. Louis, Mo.), in the proportions described in the table below were heated to 150 degrees Celsius (° C.) for about one hour in a 1,000 mL breakaway reaction kettle equipped with a mechanical stirrer and a modified Dean-Stark trap and a heating mantle. The Dean-Stark trap was filled with the reflux solvent mixed xylenes (98.5%), vented, and attached to the reaction kettle to capture any water that was driven off by the reaction.

In an effort to reduce the glycol loss, the temperature was controlled with a J-KEM Model 150 temperature controller and a J-type TEFLON coated thermocouple (J-Kem Scientific Inc. St. Louis, Mo.). The temperature was raised 10° C. per hour until the reaction mixture reached a temperature of 210° C. The temperature was held there until an acid number under 3.5 was reached. The acid number was determined by titrating 0.1M potassium hydroxide in methanol (Sigma-Aldrich, St. Louis, Mo.) into a known volume of Polymer 1 diluted in 50% toluene and isopropanol in equal amounts v/v. The indicator used was 1.0% phenol phthalein in ethanol (Sigma-Aldrich, St. Louis, Mo.).

TABLE 1
Composition of Polyester 1

| Monomer | | | Catalyst | | |
|---|---|---|---|---|---|
| | grams | moles | | grams | moles |
| IPAAdACH | 92.727.1896 | 0.560.190.6 | DBTO | 2.10 | 0.01 |
| DATMP | 284 | 72.11 | | | |

Synthesis of Polyesters 2, 3, and 4

Following the procedure described above with respect to Polyester 1, Polyesters 2, 3, and 4 were synthesized by mixing the components and proportions provided in the tables below and heated under a nitrogen blanket to a temperature of 160° C. for two hours in a 250 mL reaction flask. The temperature was raised 10° C. every two hours until the temperature reached 190° C. This temperature was maintained until an acid number under 10 was reached. The acid number was determined according to the method described with the synthesis of Polyester 1, above.

TABLE 2
Composition of Polyester 2

| Monomer | | | Catalyst | | |
|---|---|---|---|---|---|
| | grams | moles | | grams | moles |
| IPAAdANP | 23.926.2833 | 0.140.180.3 | DBTO | 0 | 0 |
| GTMP | 21 | 20.16 | | | |

TABLE 3
Composition of Polyester 3

| Monomer | | | Catalyst | | |
|---|---|---|---|---|---|
| | grams | moles | | grams | moles |
| IPAAdAEG | 28.7829.112 | 0.170.200.4 | DBTO | 0 | 0 |
| TMP | 5.2921.87 | 10.16 | | | |

TABLE 4
Composition of Polyester 4

| Monomer | | | Catalyst | | |
|---|---|---|---|---|---|
| | grams | moles | | grams | moles |
| IPAAdAHD | 24.8521.863 | 0.120.250.3 | DBTO | 0 | 0 |
| TMP | 2.9220.38 | 90.1 | | | |

The predicted hydrolytic stabilities of the polyesters synthesized are shown below in Table 5.

TABLE 5
polyacid and polyol components of the synthesized polyesters

| | Predicted | | | | |
|---|---|---|---|---|---|
| | Hydrolytic | | | | |
| Polyacid | Stability | Polyester 1 | Polyester 2 | Polyester 3 | Polyester 4 |
| IPA | | ✓ | ✓ | ✓ | ✓ |
| AdA | | ✓ | ✓ | ✓ | ✓ |
| Polyol | | | | | |
| CHDM | 17 | ✓ | | | |
| NPG | 21 | | ✓ | | |
| EG | 13 | | | ✓ | |
| HD | 15 | | | | ✓ |
| TMP | 15 | ✓ | ✓ | ✓ | ✓ |

### Analysis of the Polyesters

The hydroxyl number of Polyester 4 was determined using the ASTM-D 4274-94 standard entitled, “Test Methods for Testing Polyurethane Raw Materials: Determination of Hydroxyl Number of Polyols,” Test Method A. Because the calculated value was very close to the predicted value for Polyester 4, the predicted hydroxyl numbers were used for Polyesters 1, 2, and 3.

Using a tetrahydrofuran solvent, gel permeation chromatography (GPC), run at a solvent flow rate of about one mL per minute on Waters columns HR 0.5, HR 1.0, HT 6E, and 100 Å (Waters Corporation, Milford, Mass.), was used to determine the number average molecular weight (Mₙ) of each polyester. Differential scanning calorimetry (DSC), ramping at 20° C. per minute, was used to find the glass transition temperature (T_{g}) for each polyester.

### Crosslinking of the Coatings

The synthesized polyesters were then crosslinked, at varying crosslinking densities, with an isocyanate according to the reaction scheme discussed above. Prior to crosslinking, however, poly(ethylene glycol) (PEG) obtained from Aldrich Chemical Company (Sigma-Aldrich, St. Louis, Mo.) and having a molecular weight of 1000, and PEG having a molecular weight of 200 were each individually added to the polyester in an amount of about 5 weight percent, based on the total weight of the polyester before the crosslinking step. By adding PEG, soft segments are provided to the polyurethane coatings, increasing flexibility of the polymer chains. In addition, the coating is rendered more hydrophilic. The two different molecular weights were added because they each provide different hydrophilicity; PEG 1000 is more hydrophilic than PEG 200 because the longer, more flexible chains are able to form more hydrogen bonds with the water.

The four polyesters were crosslinked with the isocyanurate DESMODUR N-3300 (Bayer MaterialScience, Pittsburgh, Pa.) in the following ratios of polyester to isocyanurate: 1:1.1; 1:0.73; 1:0.36; and 1:0.18, using a DBTO catalyst. The resulting urethanes were then cast using a 6 mil draw down bar onto polished, degreased rolled bronze substrates and glass and allowed to cure for about 3 days.

Two separate removal systems were used to remove the coatings made with Polyesters 1-4: a polyvinyl alcohol gel, prepared as described below, a saturated sodium hydroxide/water solution, prepared as described below. The goal of using a high pH system (e.g., a pH of 8 or higher) was to provide an removal system that was easy and safe for a conservator to use, while maintaining contact with the coating for an extended period of time (e.g., at least about 20 minutes, preferably no greater than one hour).

### Polyvinyl Alcohol Gel

An approximately 4 gram (g) aliquot of polyvinyl alcohol (PVOH) was dissolved in approximately 2 milliliters (mL) of deionized water. This solution was then mixed with 15 mL of a 4% sodium tetraborate solution in deionized water. To this system, a solution of ammonia and deionized water was added until the pH was adjusted to a pH of about 11. The resulting gel was applied to the coated bronze. The water in the gel evaporated quickly, resulting the in a dry film that did not provide sufficient wetting of the surface for desired removability. The coating thickness of the was measured before and after exposure to this removal system and it was found that no significant change in coating thickness occurred. It was, therefore, believed that the removal system needed to wet the coating surface for a longer period of time.

### Saturated Sodium Hydroxide/Water Solution

The coatings were tested by immersing the coated samples in a saturated solution of sodium hydroxide (NaOH) and water, the solution having a pH of 12. The exposure of the coated samples to the NaOH solution resulted in some change to the coatings, however, as the entire sample was immersed in the alkaline solution, it may have been able to penetrate the coating from the side rather than from the top (e.g., “edge effects”). Removal was then tested by attaching to the sample glass tubes with O-rings and clamps and filling the tubes with the saturated NaOH solution, providing contact between the NaOH solution and the coated surface near the center of the surface, well away from the edges. The contact of the NaOH solution with the coatings via the glass tubes and O-rings provided a much more controlled exposure than the method of immersion, but was believed to be an impractical method for coating removal.

### Discussion of Removability for Polyesters 1, 2, 3, and 4

The polyester urethane coatings synthesized by Example 1 were too stable and did not provide the needed removability. The system that was crosslinked in a 1:0.18 polyol to urethane ratio did not cure. The three other crosslink ratios provided coatings that did cure. Thus, by reducing the crosslink density, there was slightly more removability, but the coatings needed to be exposed to very high pH levels for over 24 hours. As previously mentioned, ammonium hydroxide plus oxygen can form the complex ion Ca(NH₂)₄)²⁺ when exposed to copper. Thus, the extended period of high pH level exposure resulted in active corrosion upon the bronze substrate, an obviously unacceptable side effect.

When PEG 1000 was added, removability was very high when exposed to high pH, but was also removable when exposed to water, also an undesirable side effect.

When PEG 200 was added to the polyesters before crosslinking, removability of the system also was high when exposed to high pH only and to water only, except for Polyester 3. It is currently known why Polyester 3, which included ethylene glycol (the most hydrophilic monomer used) swelled when exposed to a high pH system, but not when exposed to water. The thickness of the Polyester 3 coating was measured to determine if any of the coating was removed, and variation in the coating's thickness was found, providing an inconsistent appearance and indicating that uniform removability of the coating was not achieved.

### Example 2

### Synthesis and Analysis of Polyesters 5, 6, and 7

Dimethylolpropionic acid (DMPA), typically used in water-borne polyurethanes, was used as a monomer in the synthesis of Polyesters 5, 6, and 7. DMPA has two hydroxyl groups that are reactive and one protected acid group:

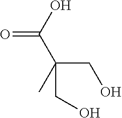

### Structure of Dimethylolpropionic Acid

Because of the hindered status of the acid group, it was believed that it would be unlikely to react during the polymerization, and therefore did not need to be protected.

Once the polyester was synthesized, it was believed that the carboxylic acid could be neutralized with an amine, making the polyester water soluble (Wicks et al., Organic Coatings, second edition, John Wiley & Sons, New York, N.Y. (1999)). To develop a removable coating, the unreacted hydroxyl group was reacted with an isocyanate in the crosslinking reaction, as discussed above with respect to Example 1, and the bond was cleaved when the coating was being removed.

### Polyester 5

To provide Polyester 5, DMPA (Sigma-Aldrich, St. Louis, Mo.) was reacted with the components and proportions thereof indicated in the table below.

TABLE 6
Composition of Polyester 5
Monomer

| | grams | moles |
|---|---|---|
| IPA | 23.01 | 0.14 |
| AdA | 28.91 | 0.2 |
| DMPA | 24.31 | 0.18 |
| HD | 21.42 | 0.18 |
| TMP | 14.31 | 0.11 |

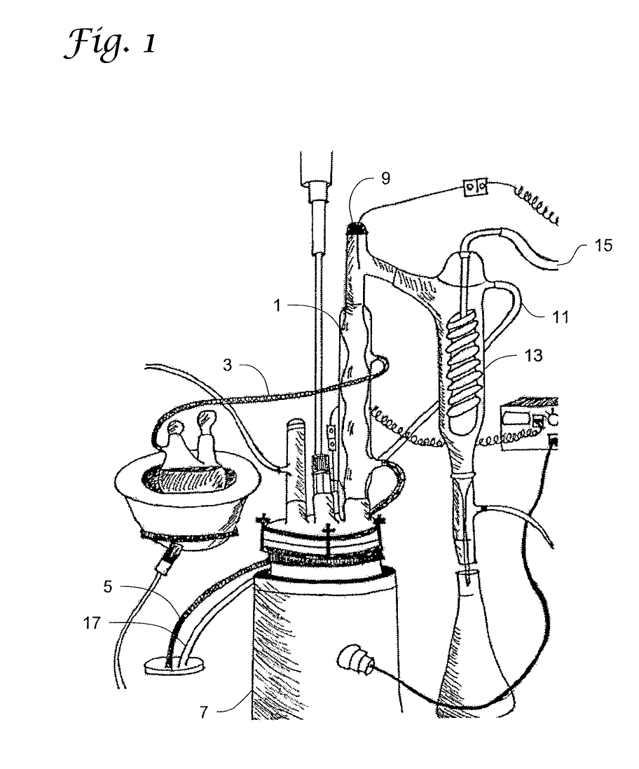

Polyester 5 were synthesized by mixing the indicated components and the mixture was heated under a nitrogen blanket to a temperature of 160° C. for two hours, and the temperature was raised 10° C. every two hours thereafter until the temperature reached 190° C. according to the procedure of Example 1. At 190° C. the IPA was still not melted, resulting in a cloudy solution of monomers and oligomers. However, when the system was heated just above 190° C., the polyester gelled. Use of the Dean-Stark trap was discontinued, and a reaction set-up using a reaction kettle, an Allihn condenser and a Friedrichs condenser, shown in FIG. 1, was used.

Instead of running cold water through the system, as sued with a Dean Starh trap, steam was run through the Allihn Condenser (1), steam in at (3), steam out at (5), in an attempt to maintain the system at a temperature of 100° C., to facilitate the condensation product leaving the reaction kettle (7). The temperature was monitored at the top (9) of the condenser (1). The Allihn condenser (1) was wrapped in glass wool for insulation. An adapter (11) was used to connect the two condensers, the adapter (11) placed at about a 70 degree angle toward the Friedrichs condenser (13). Cold water was run through the Friedrichs condenser (water in at (15), and water out at (17)), and the system was left open to the atmosphere to promote removal of the water from the reaction kettle (7).

The above reaction was run as described above, except that a 250 mL round bottomed flask was used instead of the 1000 mL reaction kettle. The polyester gelled at 190° C.

### Polyester 6

Polyester 6 was synthesized using 1,4-cyclohexane dicarboxylic acid (1,4-CHDA) provided by Aldrich Chemical Company (Sigma-Aldrich, St. Louis, Mo.). This diacid has a lower melting point than IPA, and has the following structure:

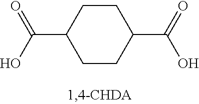 [SMILES: O=C(O)C1CCC(C(=O)O)CC1]

This polyester is synthesized using the below components and according to the procedure of Example 1

TABLE 7
Composition of Polyester 6
Monomer

| | grams | moles |
|---|---|---|
| 1,4 CHDA | 26.631 | 0.14 |
| AdA | 40.11 | 0.2 |
| DMPA | 18.79 | 0.12 |
| HD | 33.11 | 0.23 |
| TMP | 18.8 | 0.12 |

Following the procedure described above with respect to Polyester 1 (Example 1), Polyester 6 was synthesized by mixing the above components in the above proportions and heated the mixture under a nitrogen blanket to a temperature of 160° C. for two hours in a 250 mL round bottomed flask. A 2 mL aliquot of xylene was added to the reaction, and the temperature was raised 5° C. per hour until the temperature reached 185° C. The acid number was determined according to the method described with the synthesis of Polyester 1, above (Example 1), and for the first synthesis of Polyester 6, the acid number was 29.17. The synthesis was repeated, and an acid number of 30.21 was obtained. The theoretical acid number was calculated at 30, presumably due to the additional acidic functionality present in Polyester 6.

To provide a sufficient amount of the coating for testing, the volume of Polyester 6 provided needed to be increased. The following table is the initial formulation of the scaled up Polyester 6 (Scale Up A).

TABLE 8
Polyester 6 Scale Up A
Monomer

| | grams | moles |
|---|---|---|
| 1,4 CHDA | 150.88 | 0.88 |
| AdA | 182.94 | 1.25 |
| DMPA | 171.5 | 1.28 |
| HD | 97.32 | 0.82 |
| TMP | 97.36 | 0.73 |

The same reaction set up used for the synthesis of Polyester 6 was used in the initial scale up synthesis of Polyester 6, except that a 1000 mL reaction kettle was used in place of the 250 mL flask. The same heating protocol was used as was used for the synthesis of Polyester 6, the target (e.g., calculated) acid number was 36.08. After the reaction was held at 180° C. for one hour, the acid number reached 93.5 and the system gelled to the point that it was essentially unusable as a coating, resulting in a failed reaction.

The Scale Up A formulation was then synthesized according to the method of Polyester 5 (Example 2), using the Allihn condenser heated with steam and the Friedrichs condenser in place of the Dean-Stark trap and xylenes. The same heating protocol as was used for Polyester 6 was used in this synthesis. After the reaction was held at 180° C. for one hour, the acid number was found, according to the method used to analyze Polyester 6, to be 82.1.

The scale up formulation of Polyester 6 was re-evaluated. It was determined to reduce the branching within the polyester and reduce the amount of TMP used. In addition, in the previous reactions the equivalents of hydroxyl groups divided by the equivalents of acid groups was 1.5. This value was increased to 2.1 in the re-evaluated formulation, which would, it was believed, counter the possible polyol loss during the reaction.

The reformulated scaled up formulation of Polyester 6, is presented in the table below as Polyester 7.

TABLE 9
Composition of Polyester 7
Monomer

| | grams | moles |
|---|---|---|
| 1,4 CHDA | 108.41 | 0.63 |
| AdA | 157.74 | 1.08 |
| DMPA | 133 | 1 |
| HD | 234.35 | 1.99 |
| TMP | 66.52 | 0.50 |

TABLE 10
The reaction log of Polyester 7 is presented in the table below.

| | Kettle | Condenser | | |
|---|---|---|---|---|
| Time | Temperature | Temperature | Acid | |
| (hours) | (° C.) | (° C.) | Number | Comments |
| 0 | 38.9 | 20.9 | | Turn up to 150° C. |
| 0.8 | 66.1 | 24.1 | | All monomer |
| | | | | added |
| 1.3 | 106.4 | 26.3 | | Turned clear |
| 1.7 | 142.4 | 45.9 | | Water condensing |
| 2.73 | 149.6 | 51.2 | | |
| 3.5 | 150.4 | 50.0 | | Turn up to 155° C. |
| 5.6 | 155.8 | 56.8 | | Turn up to 160° C. |
| 6.9 | 161.0 | 54.6 | 70.13 | 42.51 g H₂O |
| | | | | collected |
| 8.56 | 165.0 | 42.1 | 59.22 | Turn up to 16° C. |
| 10.67 | 165.7 | 28.7 | 49.44 | Turn up to 170° C. |
| 11.7 | 168.7 | 38.0 | 48.2 | |
| 13.1 | 169.1 | 26.2 | 45.6 | Turn up to 175° C. |
| 13.5 | 179.8. | 50.7 | 40.8 | |

### Analysis of Polyester 7

The hydroxyl number of Polyester 7 was determined using the ASTM-D 4274-94 standard entitled, “Test Methods for Testing Polyurethane Raw Materials: Determination of Hydroxyl Number of Polyols,” Test Method A.

Using a tetrahydrofuran solvent, gel permeation chromatography (GPC), run at a solvent flow rate of about one mL per minute on Waters columns HR 0.5, HR 1.0, HT 6E, and 100 Å (Waters Corporation, Milford, Mass.), was used to determine the number average molecular weight (Mₙ), the weight average molecular weight (MO, the polydispersity index (PDI) of Polyester 7. Differential scanning calorimetry (DSC), ramping at 20° C. per minute, was used to find the glass transition temperature (T_{g}) for Polyester 7.

### Crosslinking of Polyester 7

Polyester 7 was crosslinked with the isocyanurate DESMODUR N-3300 (Bayer MaterialScience, Pittsburgh, Pa.) in the following ratios of isocyanurate to polyester of 1.1:1; 0.73:1; 0.36:1, using a DBTO (Sigma-Aldrich, St. Louis, Mo.) catalyst in the amount of 0.5 weight percent, based on the weight of the polyester prior to crosslinking. Additional samples were crosslinked in the same ratios, but including PEG 200 added to the coating composition in the amount of 5 weight percent (wt %), based on total weight of the polyester prior to crosslinking.

The resulting urethanes (e.g., the polyesters) were then cast using a 6 mil draw down bar onto glass plates and allowed to cure for about 2 weeks. Each coating was then exposed to water and ammonium hydroxide, supplied in a 50% NaOH solution in water by VWR International (West Chester, Pa.) for about 3 hours.

The average acid number of Polyester 7, taken the day after completion of the synthesis, was 36.07, which equates to an acid number of 7.07 when the extra acid groups of the DMPA are subtracted. The Mₙ of the polymer was 2380, the M_{w} was 3,496, and the PDI was 1.468. The hydroxyl number was 182.86, and the hydroxyl equivalent weight was 306.89.

### Discussion of Removability for Polyester 7

The basic composition prepared to assess the removability of Polyester 7 coatings was the varnish remover SAFEST STRIPPER (3M Company, St. Paul, Minn.) with a pH adjusted as follows: to the varnish remover SAFEST STRIPPER (3M Company, St. Paul, Minn.), ammonium hydroxide (NH₄OH) was added until the pH of the gel system reached 9. The coatings were then exposed to the pH-adjusted varnish remover for about 30 minutes. The treated coatings were then lightly abraded with a plastic scraper and rinsed with deionized water. Each coating was then evaluated visually to determine if coating was removed after exposure. This system was believed to be favorable if it provided desired removability, as it allowed for application of a high pH system for a desired period of time and had an appropriate viscosity for application to vertical surfaces.

Additionally, it was noted that copper and its alloys typically resist alkaline solutions, except those containing NH₄OH. NH₄OH with oxygen reacts with copper to form the soluble complex copper cations Cu(NH₃)₄²⁺. However, when copper alloys are exposed to a dilute solution of NH₄OH, the corrosion rate is typically low. It is known that the exposure of copper alloys to NH₄OH solutions at concentrations below 0.38 molar (M) provides a corrosion rate of the copper alloys that is essentially independent of the NH₄OH concentration. As the pH-adjusted varnish stripper gel includes a dilute NH₄OH solution, and as the coatings act as a barrier between the gel and the metal, it was believed that the use of NH₄OH to adjust the pH of the gel was safe in view of the goals in conservation of outdoor sculpture. However, it is advised that care should be taken to thoroughly clean with water the metal surface of any remaining p-H adjusted varnish remover gel after removal of the coating.

The results of removability tests are listed below in Table 11, which lists the coating compositions according to crosslink ratio of the polyester/isocyanate and whether or not PEG (PEG 200) is present in the composition. The removability of a coating is marked by a “Yes” or a “No”. A “Yes” indicates that the coating was swelled and easily removed. A “No” indicates that the system was unchanged by the exposure. Coatings 1, 2, 3, and 6 passed the initial removability evaluation (e.g., not removable with water, but removable with base).

TABLE 11
Results of Removability Tests

| | Crosslink | | Removable | Removable |
|---|---|---|---|---|
| Coating | Ratio(NCO:OH) | PEG 200 | with Water | with Base |
| 1 | 0.4:1 | | No | Yes |
| 2 | 0.4:1 | ✓ | No | Yes |
| 3 | 0.7:1 | | No | Yes |
| 4 | 0.7:1 | ✓ | Yes | Yes |
| 5 | 1.1:1 | | No | No |
| 6 | 1.1:1 | ✓ | No | Yes |

Combinatorial chemistry was used in the next phase, thereby providing rapid screening and thorough analysis of the synthesized polymer with removability as the initial qualifier and time to fail for the secondary qualifier. The combinatorial design included three variables: two numeric variables (NCO:OH crosslink ration density and hydrophile content) and one categorical variable (type of isocyanate crosslinker).

### Example 3

### Determination of Acceptable Coatings

The technique of combinatorial chemistry, new to the field of material science, is an incredibly useful tool for making minor formulation modifications of synthesized coatings, and for rapid and extensive screening of the coatings. The methodology is just being implemented in the field of coatings (Webster et al., J. of Coatings Technology, 1/6:34-39 (2004); Ashley et al., Polymer, 44:769-772 (2003); Borman, Chemical & Engineering News, 78:25-27 (2000; Cawse et al., Progress in Organic Coatings, 47:128-135 (2003); Cawse, “The Combinatorial Challenge,” in Experimental Design for Combinatorial and High Throughput Materials Developemnt, John Wilen & Sons, Hoboken, N.J. (2003); Chisholm et al., Progress in Organic Coatings, 45:313-321 (2002); Chisholm et al., Progress in Organic Coatings, 48:219-226 (2003); Chisholm et al., Progress in Organic Coatings, 47:112-119 (2003); Chisholm et al., Progress in Organic Coatings, 47:120-127 (2003); Chisholm et al., “Application of Combinatorial Chemistry Methods to the Development of Organic Coatings,” Materials Research Society Fall meeting, Boston, Mass. December 1-4; pages 95-100 (2003); Cremer et al., Surface and Coatings Technology, 146/147:229-236 (2001); Dusek et al., Progress in Polymer Science, 25:1215-1260 (2000); Ezbiansky et al., “High-throughput adhesion evaluation and scale-up of combinatorial leads of organic protective coatings,” Materials Research Society Fall meeting, Boston, Mass. December 1-4; pages 129-136 (2003); Hewes et al., Applied Surface Science, 189:196-204 (2002); Pilcher, J. of Coatings Technology, 73:921 (2001); Schoff, Progress in Organic Coatings, 52:21-27 (2005); Schrof et al., Athens Conference on Coatings Science and Technology, Athens, Greece, 283 (2001); and Vratsanos et al., Athens Conference on Coatings Science and Technology, Athens, Greece, 435 (2001)), and the present studies have extended these methods into the specific area of formulating coatings with removability and high performance. The application of combinatorial chemistry, allowed this research to handle and screen many more materials than possible using standard practice. One is able to produce a large variety of products in a relatively short time frame. Coatings are multi-component systems that can have many complex interactions (Webster et al., J. of Coatings Technology, 1/6:34-39 (2004); Pilcher, J. of Coatings Technology, 73:921 (2001)), and, as such, are good candidates for the application of combinatorial methods. This technique enables one to rapidly synthesize and characterize new coating polymers at a rate up to 100 times greater than standard practice (Mullin, Chemical and Engineering News, 82(30):23-32 (2004)).

One of the challenges in using combinatorial chemistry is the design of the experiment. The method of analysis must be direct and have a clear pass or fail result. The first analysis was to determine the removability of the coating. We used an increased pH to change the chemistry of the coating, making it removable. We also tested the coatings in water to make sure the system was not so hydrophilic that the system would fail if exposed to water. This type of analytical measurement, when it can be miniaturized and automated, is ideally suited to use in combination with rapid synthetic methods for preparing new polymers of designed but unevaluated removability.

The type of isocyanate selected and its crosslink density has a marked effect on the stability of the urethane system. For example, higher crosslink densities lead to more stable coatings, thus, a smaller probability that the system will be removable. In addition, a hydrophilic component within the coating could potentially help promote removability. All these variables were tested with each other in a series of factorial experiments with center points and star points to create a response surface for the different factors.

The DMPA based polyester of Example 2, Polyester 7, was crosslinked and formulated varying the following:
(1) the crosslink density (e.g., the NCO:OH ratio);
(2) the type of isocyanate;
(3) the hydrophile content; and
(4) the type of hydrophile used.

Three separate isocyanates (Isocyanate A, Isocyanate B, and Isocyanate C, discussed below) were used in the crosslinking reaction. The three separate isocyanates were chosen for their specific properties.

Isocyanate A, meta-tetramethylxylene diisocyanate (TMXDI), provided by Cytec Industries, Inc. (West Paterson, N.J.) is a difunctional isocyanate with an aromatic component. This aromatic ring was expected to increase the rigidity of the crosslinked system. The structure of TMXDI is as follows:

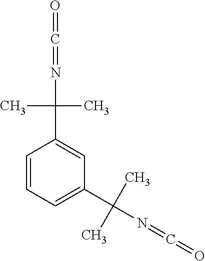 [SMILES: CC(C)(N=C=O)c1cccc(C(C)(C)N=C=O)c1]

Isocyanate B, DESMODUR N-3300 (Bayer MaterialScience, Pittsburgh, Pa.) is trifunctional and is known to crosslink well with polyester polyols. It was expected that this isocyanate would provide a coating that has a high resistance to weathering. The structure of DESMODUR is as follows:

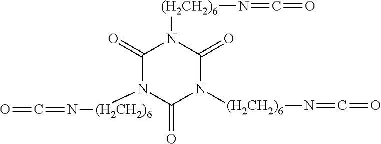

Isocyanate C, CYTHANE 3174 polyisocyanate resin (Cytec Industries, West Paterson, N.J.), a hydrophobic crosslinker based on TMXDI, is also a trifunctional molecule, and has excellent adhesion and toughness. The structure of CYTHANE 3174 polyisocyanate resin is as follows:

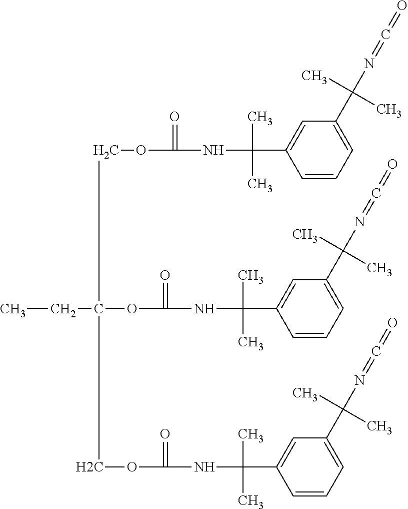 [SMILES: CCC(COC(=O)NC(C)(C)c1cccc(C(C)(C)N=C=O)c1)(COC(=O)NC(C)(C)c1cccc(C(C)(C)N=C=O)c1)OC(=O)NC(C)(C)c1cccc(C(C)(C)N=C=O)c1]

Hydrophilic components were included in some of the coatings. Five hydrophilic molecules were chosen for their distinct properties and added in various amounts during the crosslinking reaction. By adding a hydrophilic molecule to the crosslinked structure, it was anticipated that water uptake would be increased, increasing the degradation rate. It was also thought that this approach would help the crosslinked polymers break down when exposed to the high pH material.

Hydrophile 1 was polyethylene glycol (PEG), (H(OCH₂CH₂)ₙOH) provided from Aldrich Chemical Company (Sigma-Aldrich, St. Louis, Mo.). PEG 200, having a molecular weight of 200, is a very hydrophilic molecule.

Hydrophile 2 was polypropylene glycol (PPG) with a molecular weight of 425 (H(OCH(CH₃)CH₂)ₙOH) and was provided from Aldrich Chemical Company (Sigma-Aldrich, St. Louis, Mo.). PPG is also known to be a hydrophilic molecule.

Hydrophiles 3-5 were from the PLURONIC family of block copolymer surfactants from BASF Corporation (Florham Park, N.J.). Hydrophile 3, PLURONIC 17R2, has an average molecular weight of 2150, an composed of a hydrophilic chain of an ethylene oxide block copolymer sandwiched between two hydrophobic propylene oxide block copolymers.

Hydrophile 4, PLURONIC L60, and Hydrophile 5, PLURONIC L31 are the reverse of Hydrophile 3. Both PLURONIC L60 and PLURONIC L31 are composed of a hydrophobic propylene oxide copolymer sandwiched between two hydrophilic ethylene oxide copolymers. The average molecular weight of PLURONIC L61 is about 2000, and the average molecular weight of PLURONIC L31 is about 1100. PLURONIC surfactants are well known in the art.

A possible reaction scheme for the synthesis of the isocyanate-polyester crosslinked coating composition and resulting molecular structure is shown below:

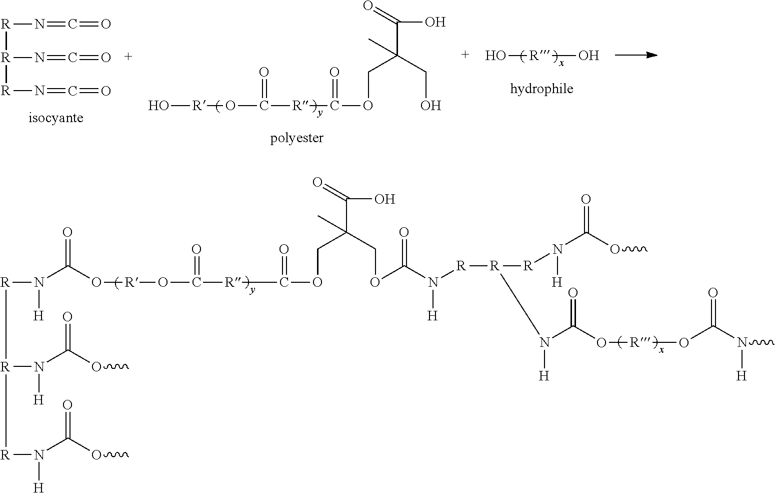

The isocyanates were crosslinked with the polyester in ratios of 0.295:1, 0.5:1, 0.589:1, 0.8:1, 0.995:1, 1.1:1, 1.304:1, 1.593:1 and 2.190:1. Additional samples were crosslinked in the same ratios, but included the hydrophilic additives at 5 wt %, 10 wt %, and 13 wt %, based on total weight of the polyester component.

Each of the above samples were cast with a 37 μm Sheen Cube film applicator (Sheen Instrument, Ltd., Kingson-Upon-Thames, Surrey, England) onto polished, degreased spring loaded rolled bronze, e.g., LULLABY (Guardian Metal Sales, Morton Grove, Ill.) having an alloy composition of 87.547% Cu, 0.005% Pb, 0.038% Fe, 10.6% Zn, and 1.76% Sn. These coatings were allowed to cure in ambient room temperature for 5 days and were evaluated for curing.

### Removability Evaluation

Each coating was exposed for 30 minutes to the 3M varnish remover, SAFEST STRIPPER (3M Company, St. Paul, Minn.), modified to a pH of 9, as described in Example 2. The system was then lightly abraded with a plastic scraper and rinsed with deionized water.

Each urethane was evaluated visually to see if the coating was removed after the exposure. Subsequently, the urethanes were immersed in a water bath for 30 minutes, and the coatings were analyzed to determine if the coating was adversely affected by the water exposure.

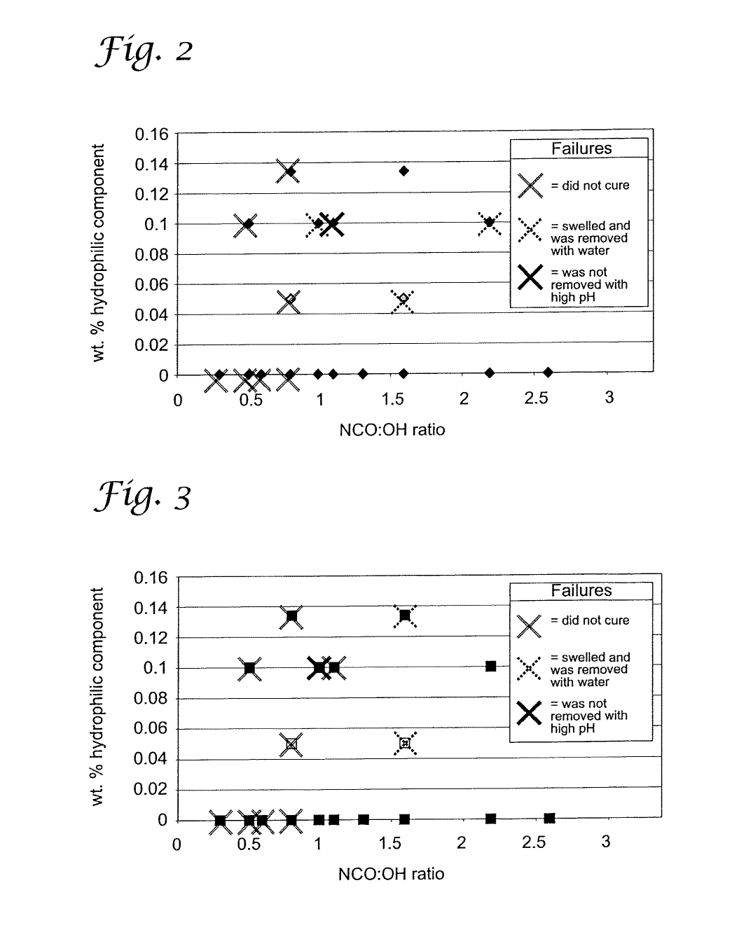

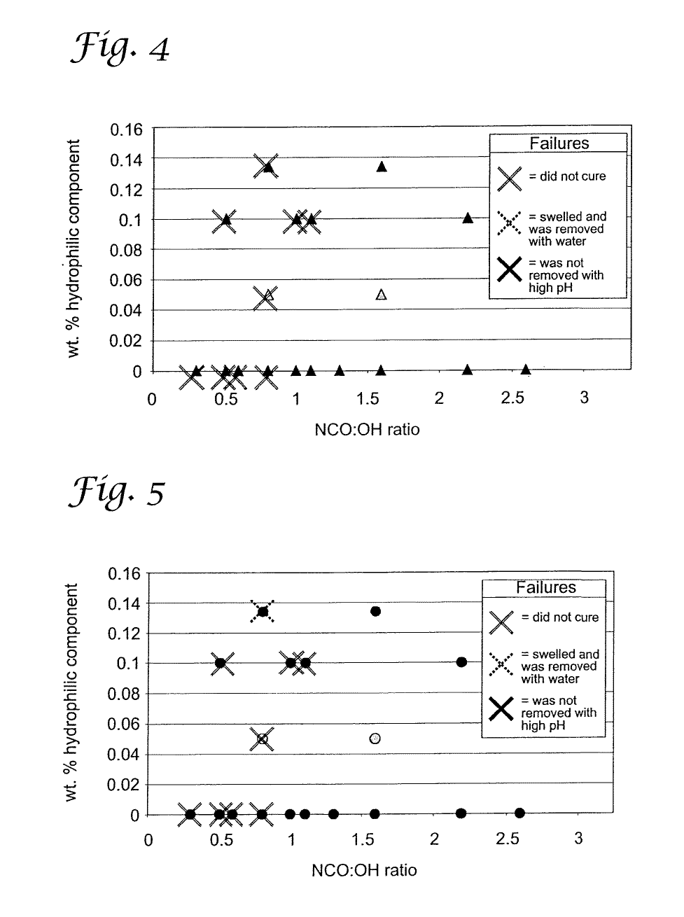

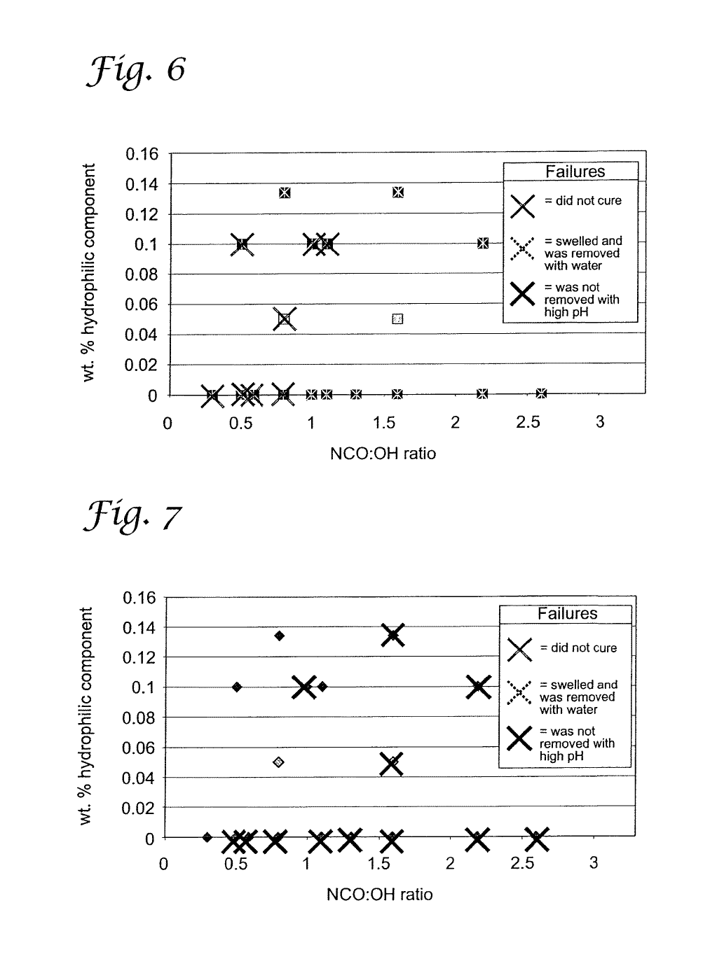

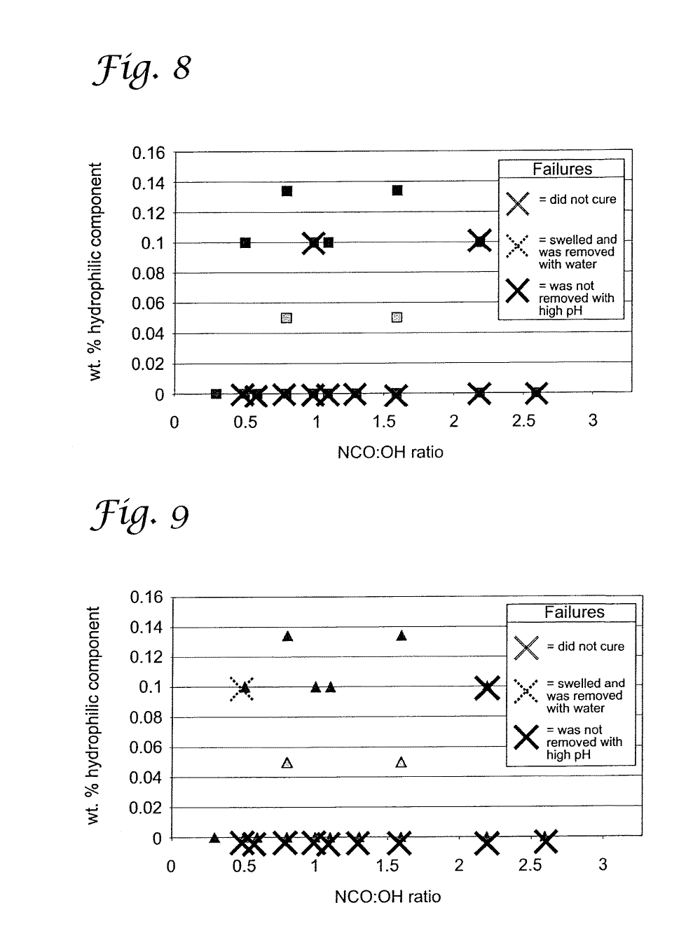

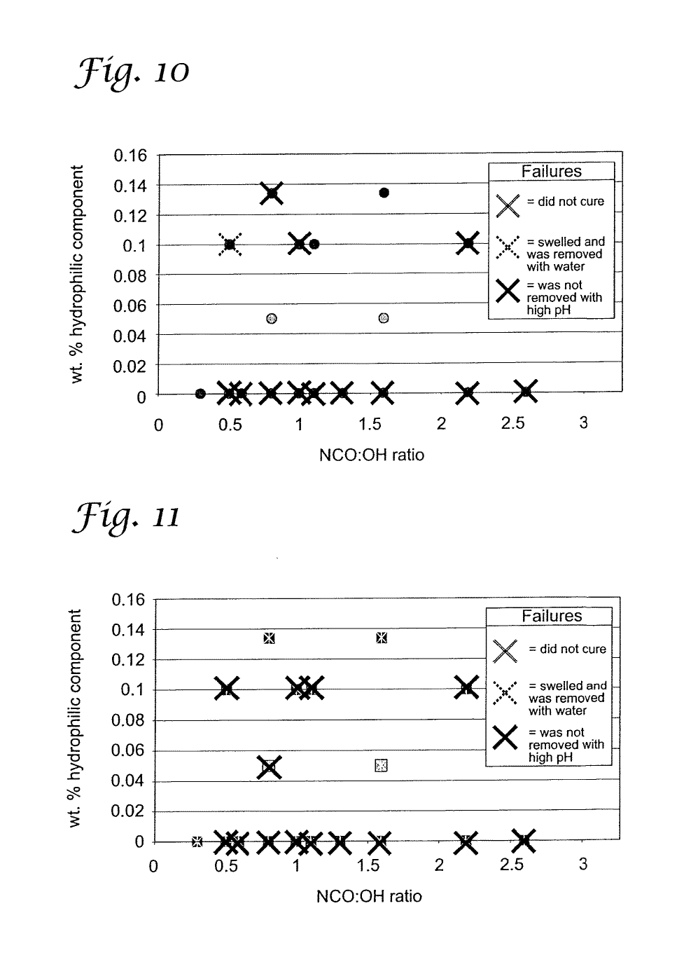

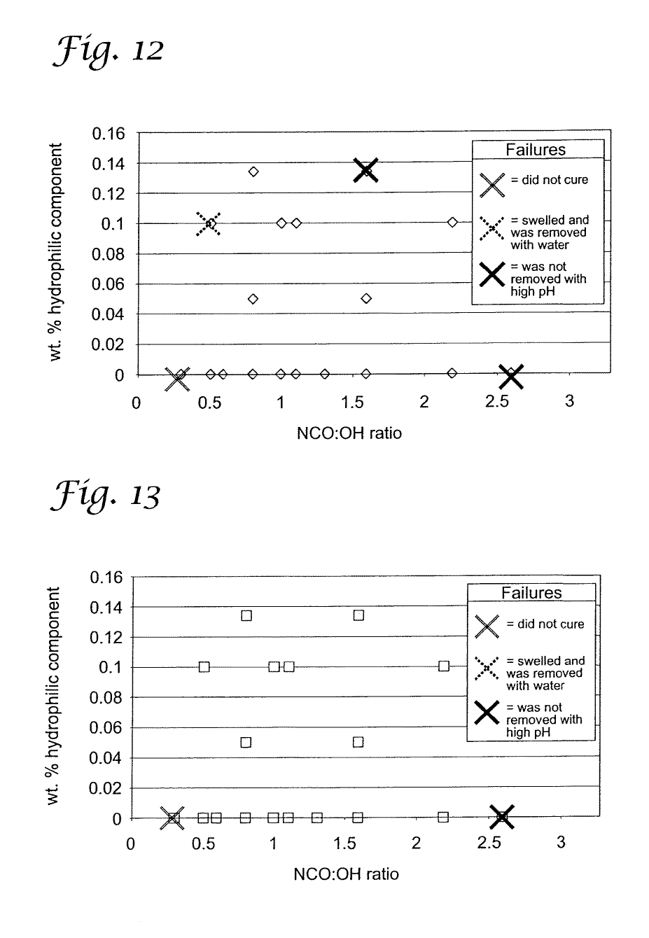

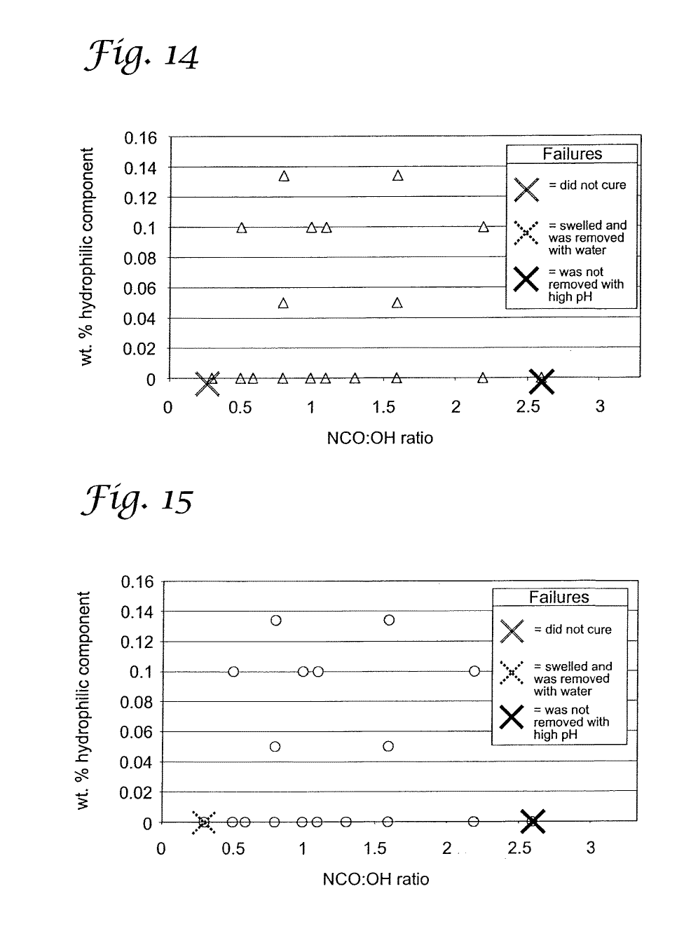

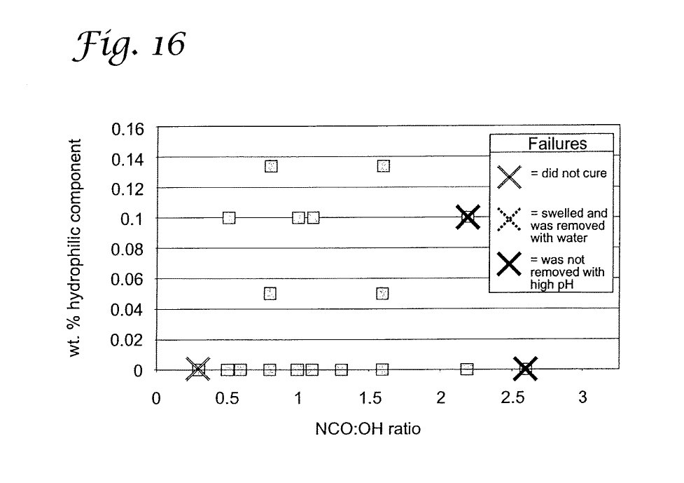

The response surfaces, provided in FIGS. 2-16, show the durability and removability of each coating as a function of the variables. FIG. 2 is the Response Surface of the coating including TMXDI and PEG; FIG. 3 is the Response Surface of the coating including TMXDI and PPG; FIG. 4 is the Response Surface of the coating including TMXDI and PLURONIC 17R2; FIG. 5 is the Response Surface of the coating including TMXDI and PLURONIC L61; FIG. 6 is the Response Surface of the coating including TMXDI and PLURONIC L31; FIG. 7 is the Response Surface of the coating including DESMODUR and PEG 200; FIG. 8 is the Response Surface of the coating including DESMODUR and PPG; FIG. 9 is the Response Surface of the coating including DESMODUR and PLURONIC 17R2; FIG. 10 is the Response Surface of the coating including DESMODUR and PLURONIC L61; FIG. 11 is the Response Surface of the coating including DESMODUR and PLURONIC L31; FIG. 12 is the Response Surface of the coating including CYTHANE 3174 and PEG; FIG. 13 is the Response Surface of the coating including CYTHANE 3174 and PPG; FIG. 14 is the Response Surface of the coating including CYTHANE 3174 and PLURONIC 17R2; FIG. 15 is the Response Surface of the coating including CYTHANE 3174 and PLURONIC L61; and FIG. 16 is the Response Surface of the coating including CYTHANE 3174 and PLURONC L31.

By analyzing the response surface, one can identify the areas of water resistance and removability. Failed coatings are reported in FIGS. 2-16 by the following symbols: a double line X indicates that the coating did not cure; a dash line X indicates that the system swelled and was removed with water; and solid bold X indicates that the system was not removed with a high pH material. The lighter shaded data points on the graphs represent the center points and were repeated six times.

### Discussion

Without the hydrophilic additives, the various coatings including the three isocyanates performed differently at the various crosslinking ratios. Isocyanate A (TMXDI) did not cure at the lower crosslink densities, but above a crosslinking ratio, of 1:1 (NCO:OH), the system was cured and removable when a high pH paste was applied. Higher crosslink densities were tried, and it was found that at a crosslink ratio of 3.5:1 (NCO:OH) the system was not removable.

Isocyanate B (DESMODUR) formed a very stable system above a ratio of 0.3:1 (NCO:OH), and was found not to be removable.

Isocyanate C (CYTHANE 3174) did not cured at the lowest crosslink densities examoned, and formed a non-removable coating at the highest crosslink density examined, but between the two extremes, formed a coating that was stable with exposure to water, but removable when exposed to the high pH paste.

The hydrophilic additives did affect the removability of Isocyanate A (TMXDI) systems. The PEG and PPG increased the hydrophilicity of the coating, so when the hydrophiles were added in the higher quantities tested, the coatings were removed with water. All of the coatings with PLURONIC additives were not affected by water immersion and proved to form a removable coating at the higher crosslink densities examined.

Coatings including Isocyanate B (DESMODUR) with the addition of PEG were very stable, and were not removable, except at the lowest crosslinking densities. With the addition of PPG, these coating systems were removable with a high pH paste below a crosslink ratio of 2.18:1 (NCO:OH). Higher quantities of PPG, up to about 25 wt %, based on total weight of the polyester, were tried at the crosslinking ratio of 1.593:1 (NCO:OH). This resulted in successful coatings, removable with a high pH system but not with water. The coating system including PLURONIC 17R2 was removed with high pH paste at crosslink ratios of between about 0.8:1 and about 1.593:1 (NCO:OH). The coating system that included PLURONIC L61 and the coating system that included PLURONIC L31 both formed successful coatings at a crosslink density of about 1.593: (NCO:OH) both at and above the hydrophilic additive content of 5 wt %, based on total weight of the polyester.

Overall the removability of coatings including Isocyanate C with the high pH paste was very successful. The addition of the hydrophilic components did not have a marked effect on removability, as the system was already removable without the addition.

It is interesting to note that the inclusion of PLURONIC 17R2, PLURONIC L61, and PLURONIC L31 in the coating systems did not evidence a marked change on the water susceptibility of the systems. Because PLURONIC 17R2 is a propylene oxide-ethylene oxide-propylene oxide block copolymer (e.g., hydrophobic-hydrophilic-hydrophobic), and PLURONIC L61 and PLURONIC L31 are ethylene oxide-propylene oxide-ethylene oxide block copolymers (e.g., hydrophilic-hydrophobic-hydrophilic), one ould expect that the response surfaces would vary according to the different hydrophilicities of the end blocks present.

### Example 4

### Accelerated Weathering of Removable Protective Coatings

The coatings evaluated in this example were those from Example 3 that were considered the most durable and successful (in terms of removability) formulas. These coatings were applied to bronze substrates and were tested to determine their resistance to weathering.

The hypothesis was that the samples that were the most robust, but were also removable had the most potential of being a strong coating. The most durable coatings were chosen for this stage of the research because it was thought removability would increase with weathering. The systems with the highest crosslink density as well as smallest amount of hydrophilic component were selected. The systems chosen for further evaluation were on the edge of removability. In addition to the urethane coatings, INCRALAC (Stan Chem, Inc., East Berlin, Conn.) was added as the control. Because INCRALAC is a popular coating currently in use on outdoor bronzes, a replacement system would need to outperform the INCRALAC. Meta-tetramethylxylene diisocyanate (TMXDI, Cytec Industries, West Paterson, N.J.), DESMODUR N3300 (Bayer MaterialScience, Pittsburgh, Pa.), and CYTHANE 3174 polyisocyanate (Cytec Industries, West Paterson, N.J.) were the isocyanates used in this study. Polypropylene glycol (PPG) PLURONIC 1782 (BASF Corporation, Florham Park, N.J.) and PLURONIC L61 (BASF Corporation, Florham Park, N.J.) were the hydrophilic additives used. The coatings studied are in the table below:

TABLE 12
Coatings subjected to accelerated weathering

| | | | | Hydrophilic |
|---|---|---|---|---|
| | | | | component |
| | NCO:OH | | Hydrophilic | (wt % of the |
| Coating | ratio | Isocyanate | component | polyester) |
| Coating 1 | 2.59:1 | CYTHANE 3174 | | |
| Coating 2 | 2.19:1 | CYTHANE 3174 | | |
| Coating 3 | 0.50:1 | DESMODUR | | |
| Coating 4 | 0.30:1 | DESMODUR | | |
| Coating 5 | 1.59:1 | DESMODUR | PLURONIC L61 | 5 |
| Coating 6 | 1.59:1 | DESMODUR | | |
| Coating 7 | 1.59:1 | DESMODUR | PLURONIC 17R2 | 5 |
| Coating 8 | 1.59:1 | DESMODUR | PPG | 5 |
| Coating 9 | 3.00:1 | TMXDI | | |
| Coating 10 | 3.50:1 | TMXDI | | |

| | |
|---|---|
| Coating 11 | INCRALAC |

The coatings were made using the formulation of Polyester 7 (Example 2). Additionally, coatings 1-11 were cast onto polished bronze and coatings 5-11 were cast onto artificially patinated bronze substrates.

Because the systems were to be exposed to UV radiation, a hindered light stabilizer and a UV absorber were also included in the formulation. To protect polymer coatings from photo-oxidation degradation, often stabilizers are added to coatings to further the coatings' effective life. If a polymer absorbs light, photo-oxidation processes are possible. The absorption of electromagnetic radiation causes electron transfers. This can further damage the polymer by radical formation that can further react with the polymer. To prevent this harmful reaction within a polymer matrix, without adding pigments as is commonly done, one can filter the harmful UV radiation before radical formation is possible by adding a quencher that will eliminate the excited state by adding a radical scavenger and/or by adding a peroxide-decomposing agent (Valet, “Light Stabilizers for Paints,” Vincenz, ed., Verlag, Hannover, Germany (1997)).

One group of organic molecules that are able to absorb and then convert the UV light to harmless heat are hydroxyphenyl benzotriazoles. Hydroxyphenyl benzotriazoles have three absorption maximas, in the short-wave UV at about 300 nanometers (nm), in the long wave UV above 320 nm, and between 335 to 340 nm.

Another class of stabilizers that has been used in coatings are hindered amine light stabilizers (HALS). Under photo-oxidation conditions, HALS are transformed into stable nitroxyl radicals. The general structure of a HALS is shown below:

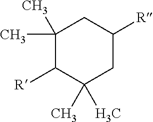

As suggested by Valet (“Light Stabilizers for Paints,” Vincenz, ed., Verlag, Hannover, Germany (1997)), the polyurethanes were formulated with 2% of at least one hydroxyphenyl benzotriazole used in conjunction with 1% HALS. TINUVIN 1130 Light Stabilizer (Ciba Specialty Chemicals, Tarrytown, N.Y.) was the hydroxyphenyl benzotriazole UV absorber used, and TINUVIN 292 Light Stabilizer (Ciba Specialty Chemicals, Tarrytown, N.Y.) was the HALS used.

These coatings bronze were exposed to accelerated cyclic weathering. In addition, the coatings were cast on quartz panels so that UV-VIS spectroscopy could be monitored throughout the weathering cycle. Physical and electrochemical testing was monitored on the weathered samples before and weekly during the 4 week weathering regime.

### Substrate Preparation

The metal substrates underwent cleaning prior to coating. The polished, cast bronze substrates were immersed in a hexane bath for approximately one minute, washed with hexane and wiped clean with a cotton cloth. The panels were then flooded with ACRYLI-CLEAN (PPG Industries, Pittsburgh, Pa.), wiped clean with a cotton cloth, and placed in an acetone bath for one minute. The samples were then wiped with acetone, ethanol, and ACRYLI-CLEAN (PPG Industries, Pittsburgh, Pa.) until the substrate passed the water drop break test (Perfetti, ed., “Metal Surface Characteristics Affecting Organic Coatings,” Federation Series of Coating Technology, Blue Bell, Pa. (1994)).

The patinated samples were briefly immersed in an acetone bath, followed by wiping, first with acetone, then with ethanol, using a soft cotton cloth. In this process some loose brown patina was lost.

The quartz panels were degreased with acetone and dust was removed with pressurized air.

### Coating Preparation

The formulations used in the coating preparation were based on Table 12. The coating components were diluted in methyl ethyl ketone (MEK) (Sigma-Aldrich, St. Louis, Mo.) when necessary and prepared as discussed with respect to the synthesis of Polyester 7 (Example 2). The hydrophilic components used were PPG (Sigma-Aldrich, St. Louis, Mo.) with a molecular weight of 425, PLURONIC 17R2 (BASF), with an average molecular weight of 2150, and PLURONIC L61 (BASF), with an average molecular weight of 2000. TINUVIN 1130 (Ciba) and TINUVIN 292 (Ciba) were added in the amounts of 2 weight percent and 1 weight percent, respectively, based on the total weight of the polyester. TMXDI (Cytec Industries, Inc.), DESMODUR (Bayer MaterialScience, Pittsburgh, Pa.) and CYTHANE 3174 (Cytec Industries, Inc.) were the isocyanates used. The crosslinking was catalyzed with dibutyltin oxide (Sigma-Aldrich, St. Louis, Mo.) in the amount of about 0.5 weight percent, based on the total weight of the polyester.

### Coating Application

The coatings were applied in triplicate to both the polished and patinated bronze samples using a GARDCO Automatic Drawdown Machine (Paul N. Gardner Company, Inc., Pompano Beach, Fla.) with a 90 μm wet film applicator rod at a traverse speed of 10 centimeters per second (cm/sec). Because the patinated samples were very porous, it was necessary to coat these samples twice to achieve the same thickness as was provided on the polished samples. The coatings were allowed to fully cure before the second topcoat was applied.

The coatings were applied to the quartz panels with a 37 μm Sheen Cube draw down bar film applicator (Sheen Instruments Ltd., Kingston-upon-Thames, Surrey, England). All of the coatings were allowed to cure at room temperature for two weeks before weathering commenced. Before weathering, the edges of the samples were taped to reduce edge effects.

### Accelerated Weathering

The samples were cycled weekly between an ultraviolet weathering chamber and a fog/humidity chamber in accordance with ASTM D 5894-96 “Standard Practice for Cyclic Salt Fog/UV Exposure of Painted Metal (Alternating Exposures in a Fog/Dry Cabinet and a UV Condensation Cabinet).” This weathering protocol began with 7 days' exposure in a PROHESION (Q-Panel Lab Products, Cleveland, Ohio) fog/humidity chamber in an environment that cycled between one hour of salt fog at 25 degrees Celsius (° C.) and one hour of no fog at 35° C. The weathering was then followed by 7 days in a QUV ultraviolet weathering chamber (Q-Panel Lab Products, Cleveland, Ohio) chamber which cycled between four hours of exposure to 340 nm UV-A light at 50° C. (this temperature was changed from the recommended 60° C. because many of the coatings tested would have been above their glass transition temperature at 60° C.), alternated with 4 hours of condensation at 50° C.

The electrolyte used for weathering was dilute Harrison's solution (0.35 weight percent (NH₄)₂SO₄ and 0.05 weight percent NaCl in H₂O), the weight percentages based on total weight of the electrolyte solution.

In this example, one-third of the samples were rotated into a WEATHER-OMETER chamber (Atlas Electric Devices Company, Chicago, Ill.) rather than into the QUV chamber (Q-Panel Lab Products, Cleveland, Ohio). The weathering cycle in the WEATHER-OMETER chamber consisted of four hours at 50° C., 95% humidity, and light irradiance of 0.55 watts per square centimeter (W/cm²) at 340 nm, followed by four hours of a dark cycle at 30° C. at 95% humidity.

### Coating Evaluation

In between each week of accelerated weathering, a digital image, film thickness, color, gloss, contact angle, EIS, and ECN were taken. The glass transition temperature was taken before weathering. A WYKO NT3300 Optical Profilometer (Veeco Instruments, Inc., Woodbury, N.Y.) was used to image the coating surfaces on the quartz panels at 10 times magnification.

### Results and Discussion

### Visual Assessment

Digital images of the coated polished bronze samples and patinated bronze samples were taken before weathering, after two weeks of weathering, and after four weeks of weathering.

Slight pitting corrosion was observed on the polished bronze coated with the CYTHANE 3174 based coatings (Coatings 1 and 2) after 2 weeks of accelerated weathering. Pitting corrosion worsened over time on Coating 1. Visually the overall color of the bronze did not significantly change on either sample.

The bronze panels with the DESMODUR topcoat with low crosslinking ratios (Coatings 3 and 4) did not result in obvious pitting corrosion, but the overall appearance of the surface turned darker and a slight tone of green. When the coating was removed, the original bronze color remained. It is thought that copper, from the bronze, leached into the coating and reacted with the salts in the weathering chamber, resulting in a change of color. The bronze under Coating 4 developed slight pitting corrosion in the areas where electrochemical tests were taken, due to the coating abrasion of putting on and removing the O-ring and clamp. The edges of bronze under Coating 4 darkened, due to water ingress.

Overall, all of the samples with coatings over the patinated bronze developed small blisters that covered the surface of the patinated bronze after 4 weeks of accelerated weathering. Blanching of the coatings also occurred during the weathering cycle. It has not been determined if the blistering occurred because of poor adhesion to the patinated borne substrate, or if the problem occurred between the two layers of coating that were applied. Because the same results were found for all the patinated coatings, including the INCRALAC system (Coating 11), it is thought that a chemical change could have occurred due to an unstable patina.

Very few visual changes were noted on the fully crosslinked DESMODUR systems on polished bronze. Coating 7 on the polished bronze surface had slight etching. The difference in this system as compared with the other DESMODUR systems was that it included the additive PLURONIC 17R2. The hydrophilic groups of the PLURONIC 17R2 additive may have been better able to absorb water, thus delivering water to the bronze surface and causing the etching.

The two TMXDI crosslinked systems had extensive failures on both substrates. Weathering of Coating 9 on the polished surface caused severe delamination of the coating and extensive corrosion build-up on the bronze surface. Weathering of Coating 9 on the patinated surface resulted in extensive powdery corrosion after 4 weeks. Weathering of Coating 10 on both the polished and patinated substrates also exhibited extensive corrosion.

The INCRALAC coating (Coating 11) on the polished bronze surface exhibited few changes. Small black spots of corrosion did form on the substrate, however. Light green powdery corrosion within the blisters occurred on the patinated bronze surface.

### Gloss Changes

Gloss, a measurement of the light reflective of a surface, may be used to quantify the degradation of a coating (Wu, Polymer Interface and Adhesion, Marcel Dekker, New York, N.Y. (1982)). As a coatings system weathers, the material erodes, scattering the light and reducing the specular reflection. One can measure the loss of gloss over time during weathering to monitor the performance of a coating.

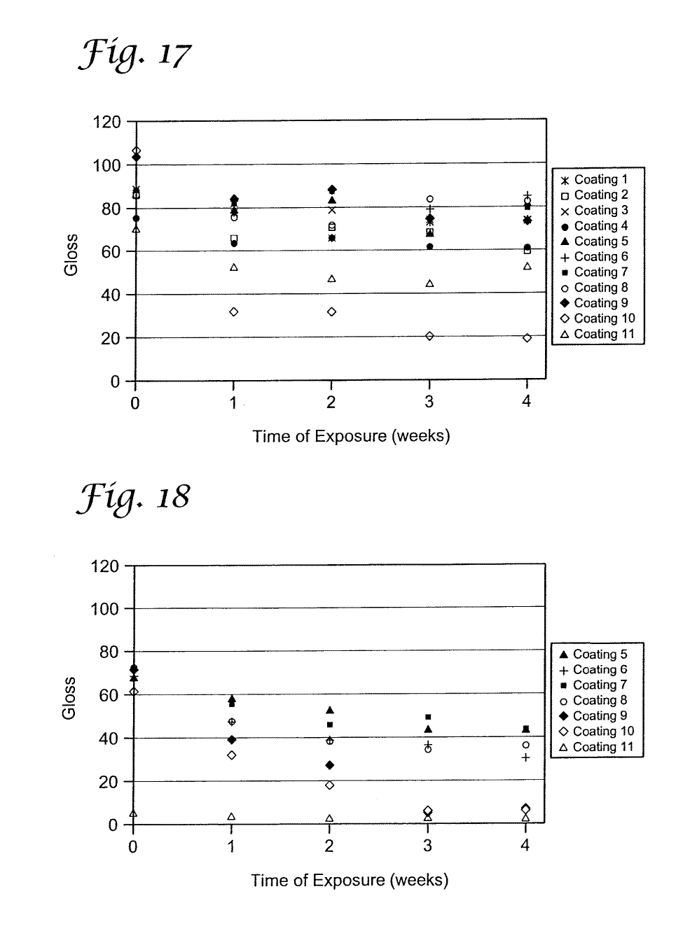

The gloss measurements taken over time are found in FIG. 17, showing gloss at a 20 degree angle over time of exposure of polished bronze coated samples, and FIG. 18, showing gloss at a 20 degree angle over time of exposure of patinated bronze coated samples.

It was found that the most information could be derived from the gloss readings taken at an angle of 20 degrees with respect to the surface. This was expected for the polished bronze samples, as they would be defined as “glossy,” but was not necessarily expected for the patinated bronze. The largest significant change on the polished bronze occurred with Sample 10, a coating including TMXDI. This supports the visual assessment of coating failure. It is interesting to note that Coating 9, also a TMXDI-containing coating, maintained a high degree of gloss in the areas of the coatings that stayed intact. Coating 11, the INCRALAC coating, started with a lower gloss reading than the prepared urethane coatings, and its gloss dropped significantly after three weeks of weathering. The gloss of the remaining coatings on the polished bronze did not significantly change during the weathering regime.

The gloss on all the coatings on the patinated bronze decreased with weathering. The DESMODUR-containing coatings (Coatings 5-8) steadily decreased over four weeks of weathering. The TMXDI-containing coatings dropped significantly, which was what was expected in view of the visual assessment of the coatings (Coatings 9 and 10). The INCRALAC system (Coating 11) started with a very low gloss. Because of the blistering and blanching of the coating systems, it was expected that the gloss would significantly drop on the patinated samples.

### Contact Angle

Typically, when a drop of liquid is placed on a solid surface, the liquid will not wet the surface, and will remain a drop (Wu, Polymer Interface and Adhesion, Marcel Dekker, New York, N.Y. (1982); Adamson et al., Physical Chemistry of Surfaces, sixth ed., John Wiley & Sons, New York, N.Y. (1997)). The angle of contact between the drop of liquid on the surface (the contact angle) is due to the difference in surface energy between the sample and the liquid. Rougher and/or more polar surfaces will have a higher surface energy and a lower contact angle. For perfect wetting of a surface, the contact angle will be zero. Contact angles have been used to predict the lifetime of a coating system, as the coated surface oxidizes and becomes rougher and more porous, the contact angle is expected to decrease.

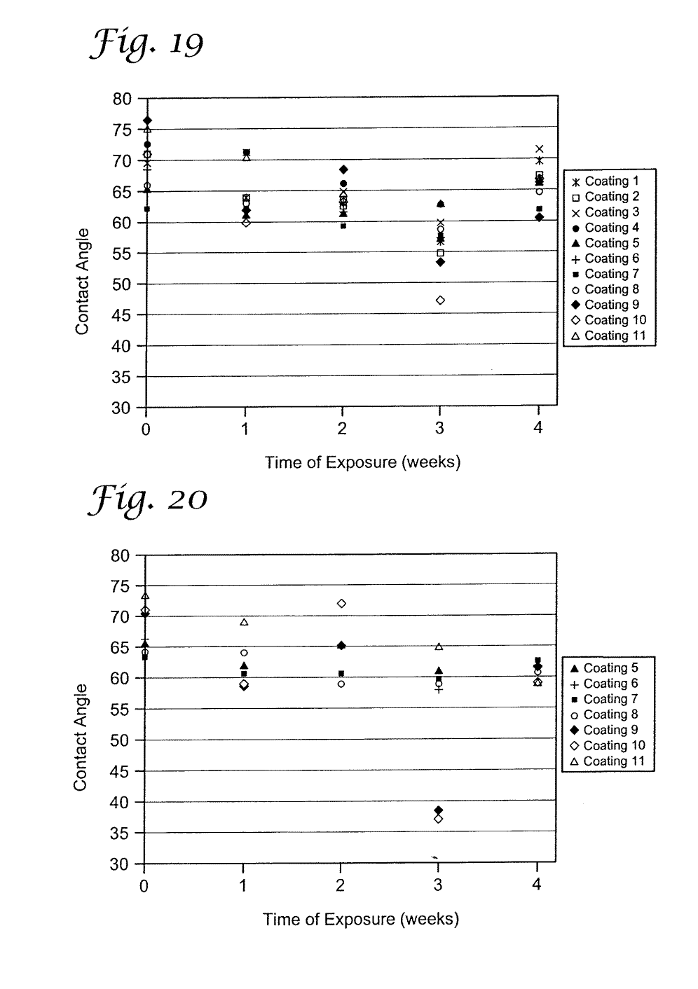

The contact angles taken over the time of exposure of the coatings on the polished and patinated bronze are shown in FIG. 19, the average contact angle versus time of exposure of the coatings on polished bronze, and FIG. 20, the average contact angle versus time of exposure of the coatings on patinated bronze.

As the samples weathered, the contact angle decreased. The was due to the surface becoming rougher and the surface energy increasing. The coatings on the polished bronze all showed a slight cyclic behavior between the weeks of UV exposure and salt fog exposure. The values decreased after the PROHESION chamber exposure, due to water saturation of the samples. The TMXDI-containing coatings (Coatings 9 and 10), exhibited a wide hysteresis of the contact angle values between the cycles, indicating that these coatings allowed more electrolyte penetration. The contact angle of the polished samples all increased significantly after week four of exposure. This could have been due to operator variance or because the samples rested outside of the weathering regime for two weeks, allowing for evaporation of absorbed water.

Other than Coatings 9 and 10, there was little change in the surface energy of the coatings on the patinated surfaces. This was surprising, considering the amount of corrosion present. It is believed that this result was obtained because the corrosion products were contained within the blisters under the surface of the coating.

### Color Changes

Color changes, which measures change in reflected and transmitted light, was measured using a spectrophotometer using the Commission Internationale de l'Eclairage (CIE) L*a*b* system which identifies color changes (ΔE*). The equation used to identify the color change is:

ΔE*=[(ΔL²)+(Δa²)+Δb²)]^{1/2}

where ΔL is the difference in lightness, Δa is the difference in red to green and Δb is the difference between blue to yellow, between the sample and the standard. Using this system, a ΔE* of 0.1 is a perceivable color change.

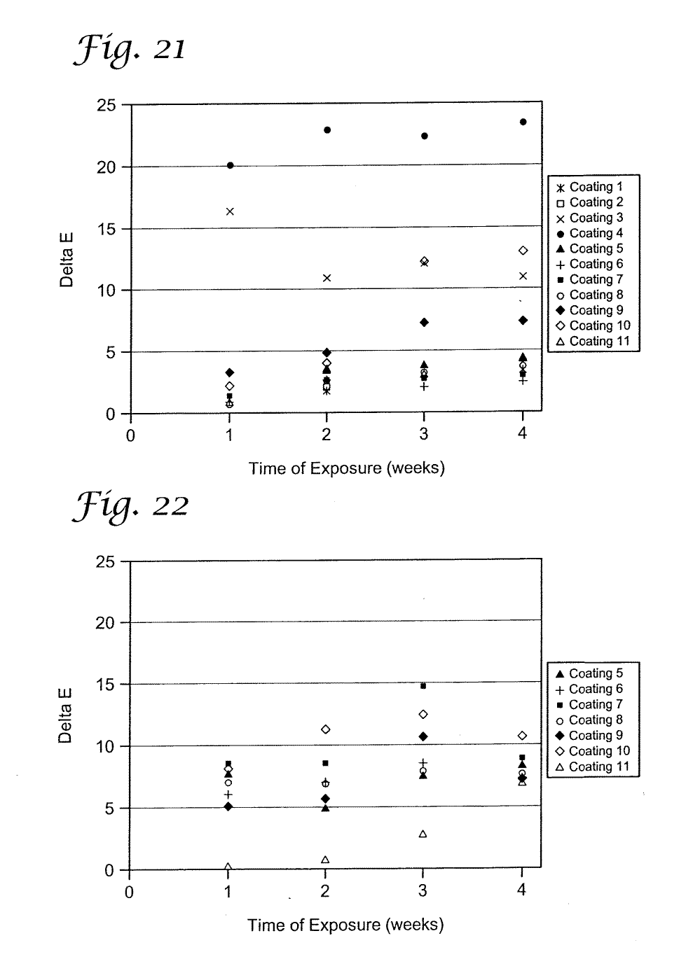

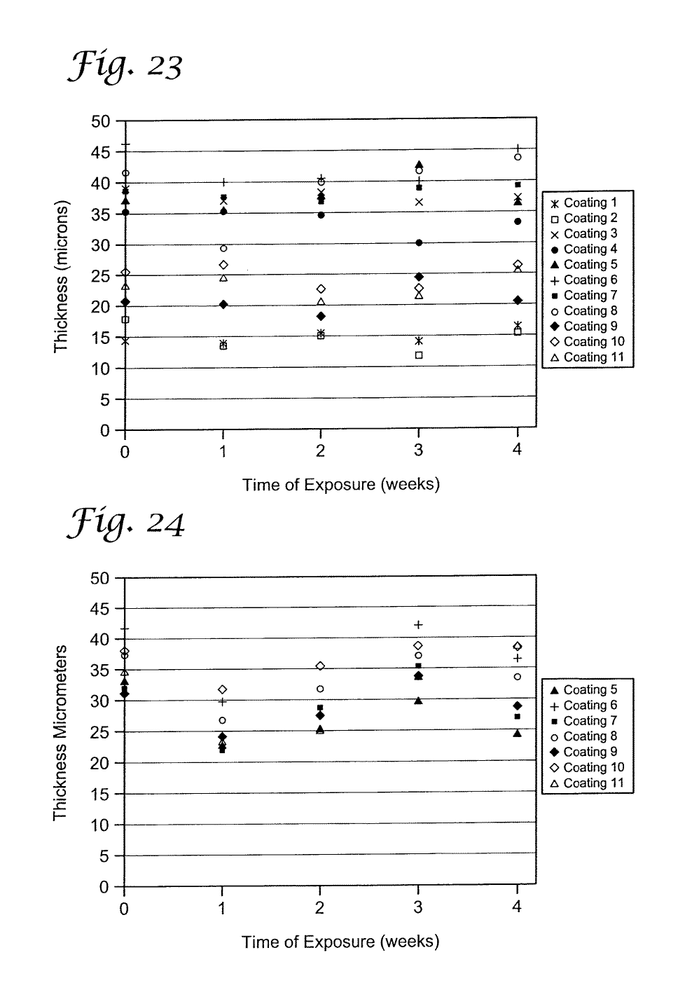

The color changes observed in the coatings and substrates, measured as described above using an X-Rtie Model SP64 spectrophotometer (X-Rite, Inc. Grandville, Mich.), are shown in FIG. 21, ΔE versus time of exposure of the coatings on polished bronze, and FIG. 22, ΔE versus time of exposure of the coatings on patinated bronze.

On the polished bronze substrate, Coating 4 exhibited the largest ΔE over the course of weathering. The cause of the large ΔE was because the L* decreased, representing a darkening, the a* decreased, indicating the surface was turning more green, and b* increased, indicating the surface was turning more yellow. The change in ΔE was anticipated by visual observations. It is interesting to note that the ΔE of Coating 3 decreased after the second week of weathering. The drop in ΔE occurred because the L* and b* values decreased closer to the original values. A large increase in ΔE occurred after 3 weeks of weathering of Coating 10 on the polished bronze. This corresponds with the large amount of corrosion product that was formed. Coatings 1, 2, 5-8, and 11 had very small ΔE values, indicating essentially no change in color.

All of the patinated samples had an increase in the L* and a slight decrease in the a*, indicating the systems were becoming lighter and more green. The development of powdery green corrosion is the cause of these changes.

### Thickness Changes

The changes in coating thickness are reported in FIG. 23, coating thickness on polished bronze versus time of exposure, and FIG. 24, coating thickness on patinated bronze versus time of exposure.

Although experimental attempts were made to achieve even thickness across all of the coatings, there was a 30 micron difference in the starting thickness of the coatings on polished bronze. This spread was maintained through the weathering and there were no statistically significant changes in the coating thickness on polished bronze.

There was much less difference in the initial coating thickness on the patinated bronze. All of the coatings decreased in thickness after the first week of weathering and then the thickness increased. The increase in coating thickness is most likely due to the development of corrosion product under the coatings, resulting in readings that appear that the coating thickness has increased.

### Noise Resistance (Rₙ)

Electrochemical Noise (ECN) is a measurement at the free corrosion potential of spontaneous and potential current fluctuations between two nominally identical working electrodes. The sources of ECN include natural variations in the electrochemical rate kinetics (Dawson, “Electrochemical Noise—The Technique for the 90's?” in Electrochemical Noise: Its Source and Measurement, SCI Materials Preservation Group, London (1991)), including uniform corrosion, pit initiation, pit growth, crevice corrosion, stress corrosion cracks, high temperatures, hydrogen evolution, mechanical abrasion effects, passive systems, under-film corrosion, microbial-induced corrosion, micro-pit dissolution, concentration fluctuations, and coatings (Oliver, Electrochemical Noise, Gamry Instruments, Lecture, Fargo, N. Dak. (2001); Dawson, “Electrochemical Noise—The Technique for the 90's?” in Electrochemical Noise Its Source and Measurement, SCI Materials Preservation Group, London (1991)).

A useful property derived from ECN is Noise Resistance (Rₙ). This value is the standard deviation of the voltage noise divided by the standard deviation of the current noise. Rₙ may be used to calculate the rate of uniform corrosion.

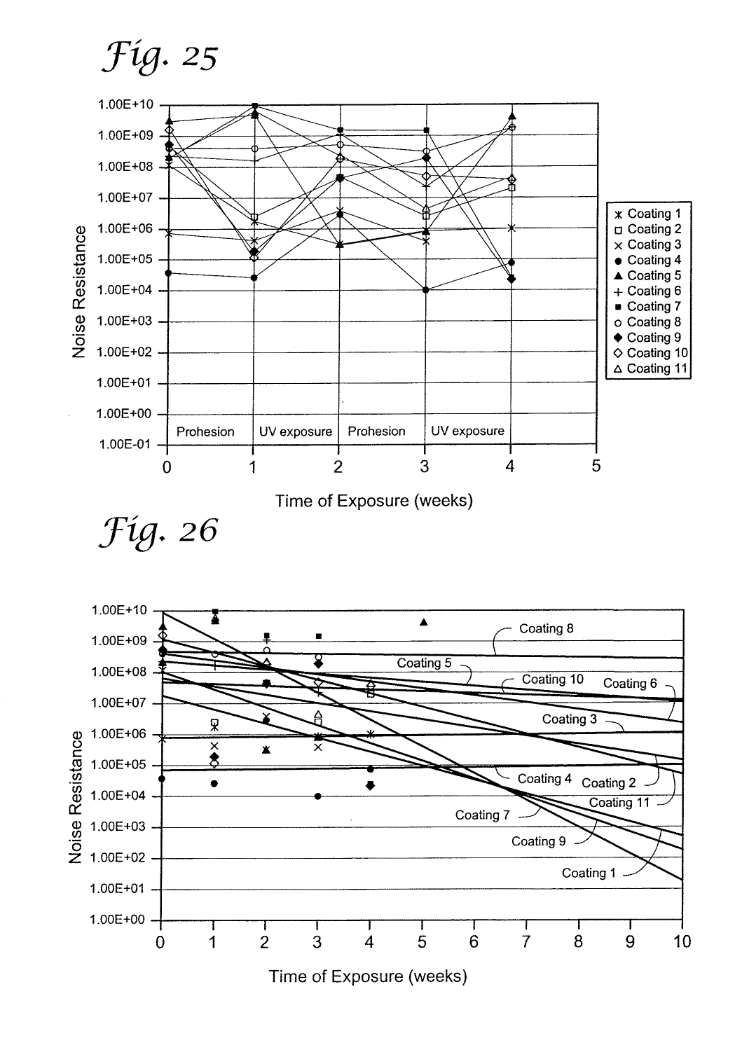

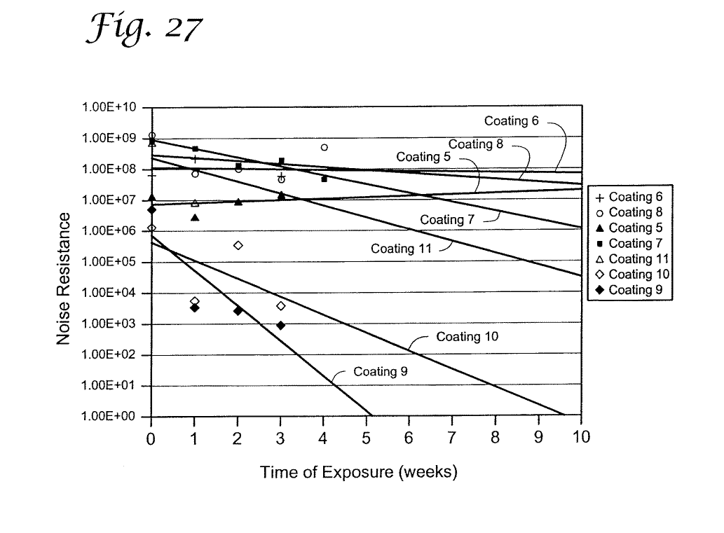

FIGS. 25 through 27 display the noise resistance (Rₙ) vs. time of exposure of the polished and patinated samples. FIG. 25 shows Rₙ versus time of exposure of coated polished bronze. FIG. 26 shows Rₙ of coated polished bronze versus time of exposure, including trend lines of the Rₙ values. FIG. 27 shows Rₙ of coated patinated bronze versus time of exposure, including trend lines of the Rₙ values. The latter two figures include exponential trend lines that are extended to give a relative lifetime of the coatings.

A cyclic trend was seen in Coatings 1, 2, 4, 9, and 11 on the polished bronze, suggesting that these coatings allowed more electrolyte penetration. The Rₙ after exposure in the PROHESION (Q-Panel Lab Products, Cleveland, Ohio) chamber decreased due to water saturation of the coating and an increased conductivity. Exposure in the QUV chamber (Q-Panel Lab Products, Cleveland, Ohio) allowed the water to evaporate and caused the Rₙ to increase.

When a trend line is added to the Rₙ values and extended past the time of exposure, one can use the performance of the coating to predict future performance, as seen in FIG. 26. Using this indicator, the DESMODUR-containing coating with PPG additive (Coating 8) on polished bronze has the potential of having the longest service lifetime. Coating 10, which failed because of brittle delamination, had a very high R. This indicates that when intact, the coating was very resistant. From the observations, the coating was also very brittle. One would expect that the lifetime prediction would be closer to that of Coating 9. The majority of the DESMODUR-containing coatings had high Rₙ values that were maintained. Coating 7, the DESMODUR-containing coating with the PLURONIC 17R₂, did not have as high a Rₙ value as the other DESMODUR-containing coatings, indicating again that the additive had a negative impact on weathering performance. All of the other DESMODUR-containing coatings outperformed the acrylic INCRALAC system, Coating 11. Coatings 4 and 5, which both had low crosslinking densities and changed color dramatically, had high Rₙ values, indicating that the coatings were providing protection.

The Rₙ values of the patinated samples indicated that even though blistering was occurring under the surface, the coatings stayed intact. The DESMODUR-containing coatings had high Rₙ values, as compared with the TMXDI-containing coatings (Coatings 9 and 10) and the INCRALAC coating (Coating 11).

### Electrochemical Impedance Spectroscopy

Electrical Impedance Spectroscopy (EIS) is a technique that determines a numerical value for the degree of corrosion protection provided by a coating of a metal substrate. This numerical value is called the impedance of the coating and is defined as any device or process that hinders the flow of current in a circuit or in an electrochemical cell. Impedance values typically range from 1×10⁹ Ohms (Ω) to as low as 100Ω. The more the coating protects the underlying metal, the higher the impedance value.

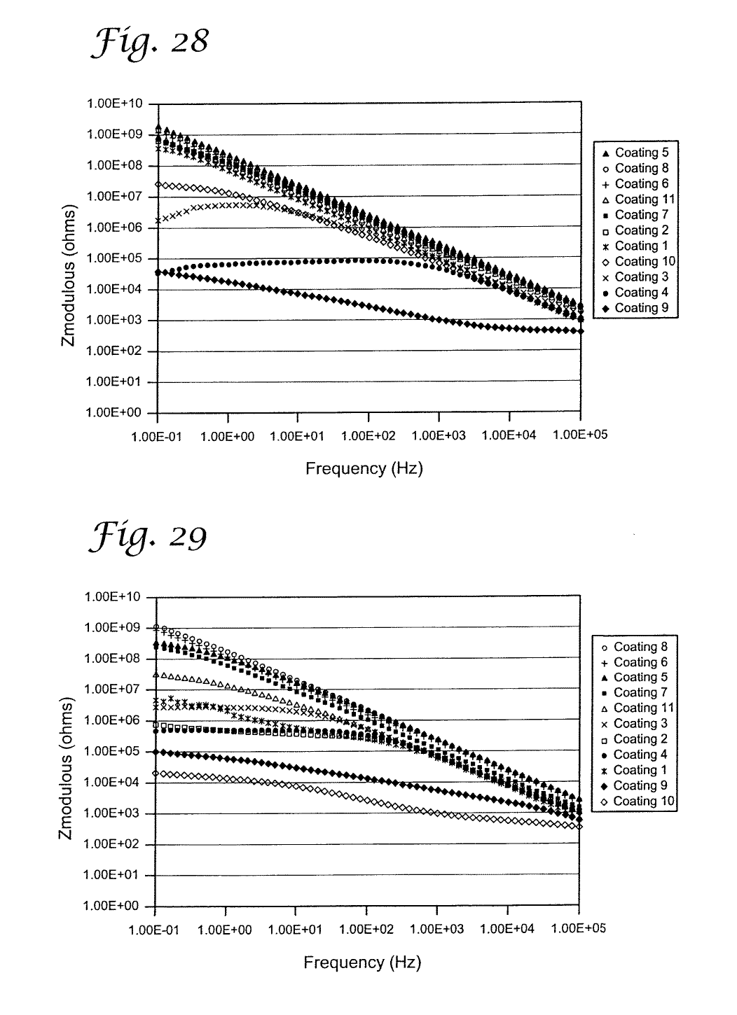

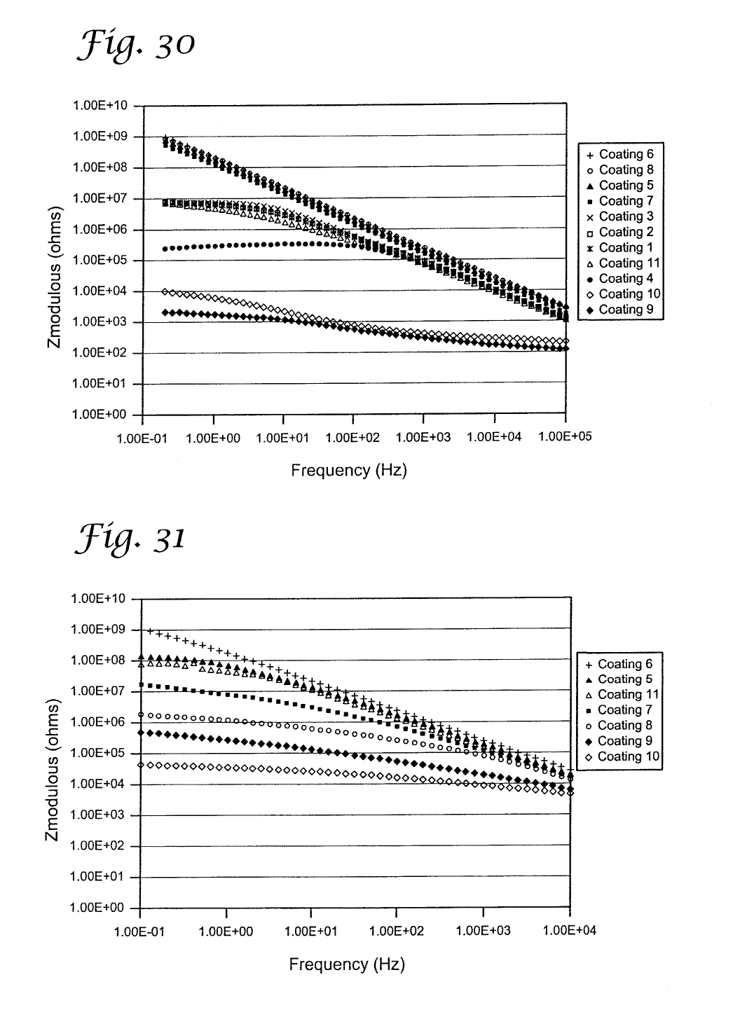

Bode Plots, the impedance plotted as log of the absolute value of impedance versus log frequency, were used for the analysis of the electrochemical impedance spectroscopy data. The data from each coating presented were from a typical sample within the coating group. Uncoated bare bronze has a low low frequency impedance of 370 Ohms (Ω). The experimental coating systems are compared to the INCRALAC system, Coating 11. The data is arranged by time of weathering, and the initial, week 2, and week 4 data are presented for the polished samples in FIG. 28 (initial Bode Plot of the polished samples), FIG. 29 (week 2 Bode Plot of the polished samples), and FIG. 30 (week 4 Bode plot of the polished samples).

The initial DESMODUR-containing coatings all had high low frequency impedance values (approximately 1.5×10⁹Ω), except for the low crosslinked systems, Coatings 3 and 4, which had low frequency impedance values of 1.77×10⁶Ω and 3.38×10⁴Ω, respectively. Coatings 9 and 10, the TMXDI-containing coatings, also had low impedance values of 3.78×10⁴Ω and 2.7×10⁷Ω, respectively.

After 2 weeks of weathering, the DESMODUR-containing coatings, Coatings 3-8, maintained the same low frequency impedance. The CYTHANE 3174-containing coatings, Coatings 1 and 2, dropped 2 and 3 orders of magnitude, respectively. TMXDI-containing coating, Coating 10, dropped 4 orders of magnitude, and Coating 9 maintained its low frequency impedance value. The low frequency impedance values of INCRALAC, Coating 11, decreased one order of magnitude.

After 4 weeks of weathering, the low frequency impedance values of the DESMODUR-containing coatings, Coatings 3-8, did not change. The low frequency impedance value of the CYTHANE 3174 coatings 1 and 2, increased one order of magnitude. This may have been due to the development of corrosion product. The TMXDI-containing coatings decreased in low frequency impedance to 2.09×10³Ω and 9.46×10³Ω. The low frequency impedance of the INCRALAC, Coating 11, decreased another order of magnitude to 7.05×10⁶Ω.

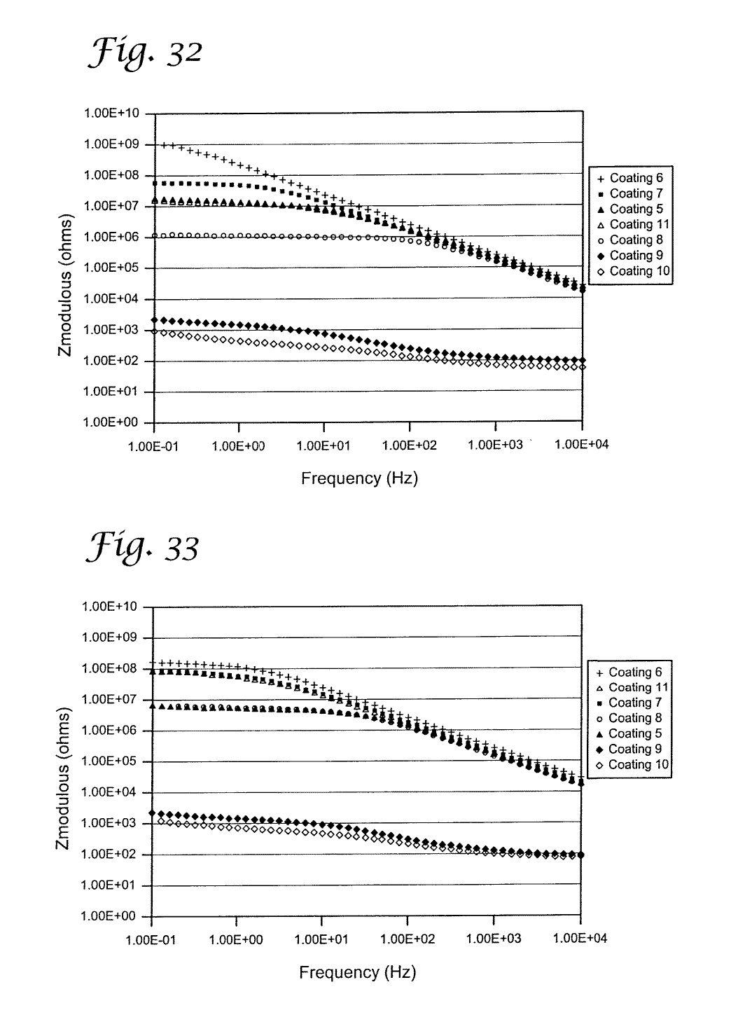

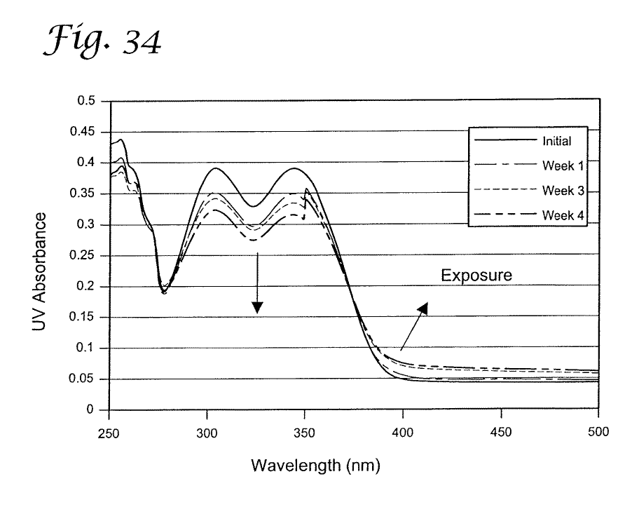

FIGS. 31 through 33 are the Bode Plots of the patinated samples before weathering and after 2 and 4 weeks of weathering. FIG. 31 shows the initial Bode Plot of the patinated samples. FIG. 32 shows the week 2 Bode Plot of the patinated samples. FIG. 33 shows the week 4 Bode Plot of the patinated samples.

Impedance data for the DESMODUR-containing coatings on patinated bronze, Coatings 5-7, initially displayed high impedances (1.38×10⁸Ω, 1.04×10⁹Ω, and 1.68×10⁷Ω, respectively). The INCRALAC system, Coating 11, also had a high initial impedance value, 7.67×10⁷Ω. These values were slightly lower than the same coating systems on the polished bronze and could be an indicator of inferior adhesion of the coating of the patinated surface. Coating 8, the DESMODUR-containing coating with PPG, had an initial impedance value of 1.82×10⁶Ω, which is 3 orders of magnitude less than the initial impedance value of the same coating on polished bronze. Coatings 9 and 10, the TMXDI-containing coatings, both had impedance values less than 1×10⁶Ω, indicating penetration of the electrolyte.

After 2 weeks of weathering, the impedance of Coating 5 and Coating 11 dropped one order of magnitude, while Coatings 6, 7, and 8 remained the same. The impedance of Coatings 9 and 10 dropped significantly down to 2.20×10³Ω and 9.17×10²Ω, respectively, indicating failure of the coatings systems.

After 4 weeks of weathering, the impedance of Coatings 5 and 7 remained the same. The impedance of Coating 6 dropped to 1.28×10⁸Ω. The impedance of Coatings 8 and 11 increased an order of magnitude, and may have been due to a devolvement of corrosion product under the coatings' surfaces.

The DESMODUR-containing coatings were found to provide more corrosion protection than the INCRALAC on the polished bronze substrate. The findings were not as conclusive on the patinated surfaces, but initial impedance values of the same coatings indicates that adhesion to the patinated surfaces may have been problematic. The TMXDI-containing coatings failed on both substrates.

### Ultraviolet Absorption

FIG. 34 shows the changes in ultraviolet absorption during exposure of Coating 10, initially, at week 1 of weathering, at week 3 of weathering, and at week 4 of weathering. The changes in UV absorption were found to be very minimal, probably because of the inclusion of the UV absorber and HALS to the polyurethane systems. The absorption of Coating 10, which failed over the 4 weeks of weathering, showed significant ultraviolet absorption changes. Beyond 295 nm, the ultraviolet absorption spectrum gradually increases and broadens as the coating is degraded.

### Profilometer Images

Coating images were taken with a WYKO NT3300 Optical Profilometer (Veeco Instruments, Inc., Woodbury, N.Y.). Each of the coatings represents a class of polymers that were tested: CYTHANE 3174 (Coating 1), DESMODUR (Coating 4), and TMXDI (Coating 10) urethanes, as well as INCRALAC (Coating 11). The PROFILOMETER images show that the surface of all four coatings changed from relatively smooth to uneven. The Coating 1 surface became rough. The Coating 4 surface developed slight blisters. The Coating 10 surface developed numerous small pits. The Coating 11 surface developed significant deep pits.

### Glass Transition Temperatures

The glass transition temperature (T_{g}) is an indicator of the properties a polymer will have. One of the physical properties that can be derived from the T_{g} is the polymer backbone flexibility. If the polymer is very flexible, the T_{g} will be lower than a polymer with a more rigid backbone.

The CYTHANE 3174- and TMXDI-containing coatings had significantly higher glass transition temperatures (T_{g}). Both of these isocyanates contain aromatic rings, which will increase the T_{g}. The low T_{g} of the DESMODUR-containing coatings indicates that the system is expected to fail under high temperatures. This did not occur after exposure in the QUV chamber (Q-Panel Lab Products, Cleveland, Ohio) and WEATHER-OMETER chamber (Atlas ElectricDevices Company, Chicago, Ill.).

### Removability Evaluation

After 4 weeks of weathering, the coatings' removability was tested. The results of the removability tests are in the table below.

TABLE 13
Removability of Coatings Subjected to Accelerated Weathering

| Coating | Removed easily | Removed with difficulty | Was not removable |
|---|---|---|---|
| Coating 1 | | X | |
| Coating 2 | X | | |
| Coating 3 | X | | |
| Coating 4 | X | | |
| Coating 5 | | X | |
| Coating 6 | X | | |
| Coating 7 | | X | |
| Coating 8 | | X | |
| Coating 9 | | | X |
| Coating 10 | | | X |

### CONCLUSIONS

It was found that removability did not increase with weathering, indicating that urethanes crosslinked at the normal 1.1:1 (NCO:OH) ratios would have performed well and maintained more removability, rather than the highly crosslinked ratios that were used. The low crosslink ratios maintained removable coatings, but resulted in green coatings that had low impedance values, indicating water ingress to the bronze surface.

The TMXDI-containing coatings (Coatings 9 and 10) failed upon visual assessment, contact angle, and electrochemical analysis. The extra urethane added to achieve the high crosslink ratios used for these coatings probably self-crosslinked, resulting in brittle coating systems.

There was no correlation between the coating thickness and the R. It was found that the systems with the highest impedance did correspond to the coatings having a thickness greater than 35 μm and had a low impedance value after 4 weeks of weathering.

The additive PLURONIC 1782 seemed to cause water ingress to the substrate, causing slight etching as well as low Rₙ values, although impedance values of the systems to which it was added were high.

The overall poor results on the patinated bronze indicates that there were problems with the adhesion of the coatings to the substrates. It is believed, due to the formation of blisters below the INCRALAC coating, that a corrosion reaction occurred beneath the surface of the coating, caused by an unstable patina. It is also believed that the systems would be improved by the addition of a wetting agent to the urethane system to better wet the patinated surface.

The DESMODUR-containing coatings, Coatings 5, 6, and 8, exhibited an overall excellent performance on the polished bronze surface. They had the highest Rₙ and impedance values, showed little visual change, and showed little change in surface energy. The T_{g} of these systems were low, but based on their performance after 4 weeks of accelerated weathering, these systems should be considered for future work. The low T_{g} may have helped to provide removability, as the polymer chains would still be flexible. Because Coating 6 provided good removability, this system should be strongly considered for future applications.

Finally, no difference was seen between the coatings weathered in the WEATHER-OMETER chamber, as compared with the QUV chamber. As the samples were weathered for only 2 weeks in both chambers, it may be that differences would arise if the samples were weathered for a longer period.

The complete disclosures of all patents, patent applications including provisional patent applications, and publications, and electronically available material (e.g., GenBank amino acid and nucleotide sequence submissions) cited herein are incorporated by reference. The foregoing detailed description and examples have been provided for clarity of understanding only. No unnecessary limitations are to be understood therefrom. The invention is not limited to the exact details shown and described; many variations will be apparent to one skilled in the art and are intended to be included within the invention defined by the claims.

1-25. (canceled)

26. A curable protective coating composition comprising:
(a) a hydroxyl-terminated polyester comprising at least one ionizable group; and
(b) a crosslinking agent.

27. The curable coating composition of claim 26, wherein the ionizable group is a carboxylic acid or a sulfonate.

28. The curable coating composition of claim 26, wherein the polyester is formed by polymerization of at least one polyol monomer and at least one polyacid monomer, at least one of said polyol or polyacid monomers comprising the ionizable group.

29. The curable coating composition of claim 28, wherein the polyol monomer comprises more than two hydroxyl groups.

30. The curable coating composition of claim 28, wherein at least one constituent monomer of the polyester is a dually functional monomer comprising (a) functional groups that participate in the polymerization reaction and (b) the ionizable group.

31. The curable coating composition of claim 30, wherein the dually functional monomer comprises a polyol monomer.

32. The curable coating composition of claim 30, wherein the dually functional monomer comprises a polyacid monomer.

33. The curable coating composition of claim 28, wherein the ionizable group does not participate in the polymerization reaction to form the polyester.

34. The curable coating composition of claim 28, wherein the ratio of hydroxyl groups to carboxylic acid groups (OH:COOH) participating in the polymerization reaction to form the polyester is between about 1.05 and 1.5.

35. The curable coating composition of claim 26, wherein the polyester is a branched polyester.

36. The curable coating composition of claim 26, further comprising a hydrophilic component which does not form part of the polyester.

37. The curable coating composition of claim 36, wherein the hydrophilic component comprises a polyether polyol.

38. The curable coating composition of claim 36, wherein the hydrophilic component comprises polyethylene glycol.

39. The curable coating composition of claim 26, wherein the crosslinking agent comprises an isocyanate functional resin, an amino resin or an epoxy resin.

40. The curable coating composition of claim 26, wherein the crosslinking agent comprises an isocyanate, and the amount of isocyanate used in the coating is characterized by a ratio of isocyanate groups to hydroxyl groups on the polyester (NCO:OH) of about 0.3:1 to about 3.5:1.

41. The curable coating composition of claim 26, wherein the crosslinking agent comprises an isocyanate comprising three or more isocyanate groups.

42. The curable coating composition of claim 28, wherein the polyol monomer is selected from the group consisting of dimethylolpropionic acid; hexanediol; 1,5-pentanediol; ethylene glycol; 1,2-propylene glycol; 1,3-propylene glycol; 2-methyl-1,3-propanediol; 2,2-dimethyl-1,3-propanediol; 2-butyl,2-ethyl-1,3-propanediol; 1,4-cyclohexanedimethanol; 2,2,4-trimethyl-1,3-pentanediol; hydroxypivalylhydroxypivalate; trimethylolpropane; trimethylolethane; glycerol; pentaerithritol; and di-trimethylolpropane.

43. The curable coating composition of claim 28, wherein the polyacid monomer is selected from the group consisting of adipic acid; phthalic anhydride; phthalic acid; isophthalic acid; terephthalic acid; glutaric acid; succinic acid; succinic anhydride; maleic acid; maleic anhydride; itaconic acid; itaconic anhydride; 1,4-cyclohexanedicarboxylic acid; 1,3-cyclohexanedicarboxylic acid; hexahydrophthalic anhydride; hexahydrophthalic acid; methylhexahydrophthalic anhydride; and tetrahydrophthalic anhydride.

44. The curable coating composition of claim 26, made by the process of combining
(a) a hydroxyl-terminated polyester formed by the polymerization of at least one polyol monomer and at least one polyacid monomer; wherein at least one of said monomers comprises at least one ionizable group; with
(b) a crosslinking agent;
to yield the curable coating composition.

45. A cured coating prepared from the coating composition of claim 26.

46. The cured coating of claim 45, wherein the crosslinking agent reacts with the polyester to form the cured coating.

47. The cured coating of claim 46, wherein the crosslinking agent reacts with hydroxyl groups on the polyester to form the cured coating.

48. The cured coating of claim 45, wherein the ionizable group does not participate in the crosslinking reaction.

49. The cured coating of claim 45, wherein curing takes place at ambient temperatures.

50. The cured coating of claim 45, wherein curing takes place over a period of about 2 weeks to about 6 weeks.

51. The cured coating of claim 45, wherein the cured coating is durable when exposed to natural weathering and man-made pollutants.

52. The cured coating of claim 45, wherein the cured coating is removable with a removal composition having a pH of about 8 or greater.

53. The cured coating of claim 52, wherein the cured coating is removable with a removal composition having a pH of about 8 to about 10.

54. The cured coating of claim 45, wherein the cured coating swells when exposed to high pH.

55. The cured coating of claim 45, wherein the cured coating is removable by light rubbing or abrasion.

56. An article coated with the curable coating composition of claim 26, wherein the curable coating composition is cured.

57. The article of claim 56, wherein the article comprises a coated bronze surface.

58. The article of claim 56, wherein the article is a bronze sculpture.
